(19) United States
(12) Patent Application Publication
(10) Pub. No.: US 2010/0146096 A1
(43) Pub. Date: Jun. 10, 2010

(54) COMMUNICATION SYSTEM

(75) Inventors: Tadashi Takahashi, Kawasaki (JP); Hiroaki Miyata, Yokohama (JP); Koji Nishii, Fujisawa (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/626,048

(22) Filed: Nov. 25, 2009

(30) Foreign Application Priority Data
Nov. 28, 2008 (JP) 2008-303428

(51) Int. Cl. G06F 15/173; G06F 15/16

(52) U.S. Cl. 709/223; 709/227

(57) ABSTRACT

A communication system controls connection to the interface, such as an IP line to which a subscriber terminal connects, according to the information in the tables in which information is registered and updated, wherein the registered and updated information includes information as to which line type, ISDN line or analog line, is used and as to which high way (HW) of a time-division switch (TSW) of a media gateway (management device) is selected for providing TSs (timeslots) for use in the connection, as well as subscriber information on services for which a subscriber contracts.

### INCORPORATION BY REFERENCE

The present application claims priority from Japanese application JP2008-303428 filed on Nov. 28, 2008, the content of which is hereby incorporated by reference into this application.

### BACKGROUND OF THE INVENTION

The present invention relates to a media gateway that provides means for connecting a user, who uses a voice call and data communication via a conventional ISDN (Integrated Services Digital Network) line, to an IP network.

Recently, networks are moving increasingly to Next Generation Networks (NGN) and to all-IP (Internet Protocol) networks. The trend toward All-IP transformation is growing also in the public switched telephone networks (PSTN) where analog lines and ISDN (Integrated Services Digital Network) lines are used. In addition to this trend, the move from switching networks, where toll switches are included, to IP (Internet Protocol) networks is taking place in the public switched telephone networks (PSTN). The primary reason for this move is that the cost of the routers and switches used in an IP (Internet Protocol) network is much lower than that of the switches used in the public switched telephone networks (PSTN) and so the maintenance cost may be reduced.

In the voice call service, switching networks are moving to IP networks based on the VoIP (Voice over Internet Protocol) technology that transmits voices via IP packets.

Similarly, SIP (Session Initiation Protocol) is standardized in RFC3261 as the session control protocol for communication connection and so, by installing a SIP server in an IP network, a VoIP-based voice call may be made between a gateway (GW) and terminals.

In the data communication service, a receiving side number is specified for the Internet service provider (ISP) of the connection destination to access the RAS (Remote Access Server) of the connection destination via the PSTN network for establishing an IP connection. Recently, the connection is made using the common receiving side number, and the RAS (Remote Access Server) of the connection destination distributes the connections to ISPs using the connection identifiers (domain names).

In future, it is expected that more and more PSTNs will increasingly move to IP networks not only in switching networks but also in subscriber's networks.

Another approach is that, as broadband access is spreading rapidly via optical or ADSL connection lines for high-speed Internet connection, the data communication service and VoIP communication service are provided by including subscriber line into an IP network.

However, because not all subscribers do not move to broadband access lines such as optical lines or ADSL lines, an actual network includes both subscribers, those who have moved to optical lines or ADSL lines and those who continue to use analog lines and ISDN lines.

For example, JP-A-2003-348230 describes a configuration in which data communication is performed between a user terminal and the Internet network by connecting to a media gateway (MG) via a local switch on the PSTN network and by transferring data via an IP network.

JP-A-2001-326724 describes another configuration in which, if a connection request is issued from a terminal connected to an MG and the terminal with the receiving side number is connected to the same MG, the connection request is not converted to VoIP but the requesting terminal is connected to the receiving terminal within the MG.

### SUMMARY OF THE INVENTION

It is expected that more and more subscriber's networks will increasingly move to IP networks in future. However, because analog lines and ISDN lines are used as access lines as long as the subscriber interface, such as analog lines and ISDN lines, continues to exist, IP transformation is carried out including, but not beyond, the subscriber line terminator. Therefore, when a connection is established directly from a subscriber line terminator to an IP network not via the PSTN, the subscriber line terminator cannot identify from the receiving side number whether the receiver is a voice terminal or a data communication terminal. Therefore, one of the problems is that the receiving side numbers, which are distributed conventionally in the PSTN network, cannot be used to determine whether the connection destination is a voice terminal or a data terminal. Another problem is that, when an IP network is extended to a subscriber network, the users using analog lines and ISDN lines cannot use the voice call service and the data communication service.

In addition, when data communication is performed between a user terminal and the Internet by connecting to the media gateway (MG) via the local switch in the PSTN network and by transferring data via an IP network, the problem is that PSTN network is still required to allow the interface UNI, used to connect to the Internet, to return data from the IP network to the PSTN network.

A network configuration is built in which a subscriber line terminator, which serves multiple telephones, PCs, and data terminals connected by analog lines and ISDN lines, is installed on the edge of an IP network as a media gateway and, in addition, routers and servers (for example, SIP servers) are installed in the IP network. When a call placing request is received from an analog user and an ISDN user, the media gateway converts the request, for example, to an SIP protocol message and sends a session connection request to the SIP server. In this way, the media gateway controls the connection to the IP network without connecting to an conventional PSTN network where local switches and toll switches are used. When the connection request described above is received, the SIP server references the subscriber information management table, managed in the SIP server, using the telephone number of the connection destination for extracting the IP address and the connection mode of the connection destination. If the connection mode is not included in the extracted information, the SIP server recognizes that the call is a voice call and sends a session connection request to the connection destination. When the session connection is completed, the voice call via VoIP becomes possible. On the other hand, if the connection mode is included in the extracted information, the SIP server determines that the communication is a data communication, adds the extracted connection mode to the information on the 200 OK packet that is the response to the session connection message INVITE, and notifies the media gateway of the information. The IP address of the connection destination may also be added to the message described above.

When the 200 OK packet that is a response packet to the session connection request from the SIP server is received, the media gateway extracts the IP address and the connection mode of the connection destination from the 200 OK packet, which is a response packet, and performs the operation according to the extracted information. If the extracted connection mode information indicates PPPoE, the media gateway operates as a PPPoE client and establishes a PPPoE session connection with the BAS. If the extracted information indicates L2TP, the media gateway operates as a LAC and establishes an L2TP connection with the LNS installed in an ISP.

The above operation makes the data communication possible. The information on the mode of connection from the SIP server to the connection destination allows the SIP server to determine, based on the telephone number of the connection destination, which communication is performed, voice or data, thus enabling the communication system to perform multiple types of operation.

As an example of the present invention, the tables are used in which information is registered and updated, wherein the registered and updated information includes information as to which line type, ISDN line or analog line, the user uses and as to which high way (HW) of a time-division switch (TSW) of a media gateway (management device) is used for providing TSs (timeslots) for use in the connection as well as subscriber information on services for which a subscriber contracts and, based on the information stored in the tables described above, a subscriber is connected to a connection destination via the interface such as an IP line. In addition, for subscribers who are terminal users, a table is provided to manage the information on the connection destinations to which sessions are connected and the information on the subscribers and the modes of connection to the connection destination are managed based on the information in the table described above to determine the type of communication, data or voice. Alternatively, a server (for example, a SIP server) may have a subscriber information management table in which information on the subscribers and connection destinations is managed and, in that table, the connection mode information for identifying the communication type, voice or data, may be managed. When a session connection request is received, the SIP server described above may use the telephone number of the connection destination to determine, via the management table, which communication type, voice or data, is performed on the connection destination. And, if it is found that the data communication is performed, the SIP server may return a response message, to which the connection mode added, to the calling source.

As an example of a communication system of the present invention, there is provided a communication system that comprises a plurality of terminals; a management device connected to the terminals; a network connected to the management device; a server connected to the network; and a first table in which information on a connection status on the network is stored. The management device comprises a second table in which information on the terminals is stored; a third table in which information on sessions performed via the network is stored; a fourth table in which information on service providers connected via the network is stored; and an interface that controls a connection between the terminals and the network based on information read from the second table, the third table, and the fourth table wherein, when a session connection request is received from the management device, the server sends a response message based on information read from the first table.

When a PSTN network is replaced with an IP network, the communication system of the present invention accommodates users who use the voice call, data communication, and packet switching services via an ISDN line. In addition, working in conjunction with a SIP server, the communication system of present invention can determine the communication type, voice call or data communication, using only the information on the called numbers and, for the data communication, allows multiple connection methods to be used compatibly.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the network configuration.

FIG. 2 is a diagram showing the general configuration of the network.

FIG. 3 is a diagram showing the configuration of a MG 30.

FIG. 4 is a diagram showing the configuration of a SIP server 50.

FIGS. 5A and 5B are diagrams showing an example of packets used by ISDN line users and analog line users.

FIG. 6 is a diagram showing an example of a rule for allocating TSs to HWs.

FIG. 7 is a diagram showing a subscriber management table managed by the MG 30.

FIGS. 8A, 8B, 8C, 8D, 8E, 8F, and 8G are diagrams showing session connection management tables managed by the MG 30.

FIGS. 9A and 9B are diagrams showing data management tables managed by the MG 30.

FIG. 10 is a diagram showing a domain management table managed by the MG 30.

FIGS. 11A, 11B, and 11C are diagrams showing subscriber information management tables managed by the SIP server 50.

FIGS. 12A, 12B, 12C, 12D, and 12E are diagrams showing connection management tables managed by the SIP server 50.

FIG. 13 is a diagram showing the communication sequence between the MG 30 and the SIP server 50 for registering subscriber information.

FIG. 14 is a diagram showing the communication sequence between the MG 30 and the SIP server 50 for deleting subscriber information.

FIG. 15 is a diagram showing the communication sequence performed before voice communication is started.

FIG. 16 is a diagram showing the communication sequence performed before a voice call is disconnected.

FIG. 17 is a diagram showing the communication sequence performed before data communication, indicated by the circled numeral 2, is started.

FIG. 18 is a diagram showing the communication sequence performed before data communication, indicated by the circled numeral 2, is terminated.

FIG. 19 is a diagram showing the communication sequence performed before data communication, indicated by the circled numeral 3, is started.

FIG. 20 is a diagram showing the communication sequence performed before data communication, indicated by the circled numeral 3, is terminated.

FIG. 21 is a flowchart showing the open processing performed by the MG 30.

FIG. 22 is a flowchart showing the close processing performed by the MG 30.

FIG. 23 is a flowchart showing the registration/deletion processing performed by the SIP server 50.

FIG. 24 is a flowchart showing the 200 OK reception processing performed by the MG 30.

FIG. 25 is a flowchart showing the SETUP reception processing performed by the MG 30.

FIG. 26 is a flowchart showing the calling processing performed by the MG 30.

FIG. 27 is a flowchart showing the INVITE reception processing performed by the SIP server 50.

FIG. 28 is a flowchart showing the INVITE reception processing performed by the MG 30.

FIG. 29 is a flowchart showing the CALLPROC processing performed by the MG 30.

FIG. 30 is a flowchart showing the 200 OK reception processing performed by the SIP server 50.

FIG. 31 is a flowchart showing the connection distribution processing performed by the MG 30.

FIG. 32 is a flowchart showing the authentication request reception processing performed by the MG 30.

FIG. 33 is a flowchart showing the BYE reception processing performed by the SIP server 50.

FIG. 34 is a flowchart showing the BYE reception processing performed by the MG 30.

FIG. 35 is a flowchart showing the REL COMP reception processing performed by the MG 30.

FIGS. 36A, 36B, 36C, and 36D are diagrams showing subscriber management tables managed by the MG 30.

FIG. 37 is a diagram showing an example of a 200 OK packet sent by the SIP server 50.

FIG. 38 is a diagram showing an example of a 200 OK packet sent by the SIP server 50.

### DESCRIPTION OF THE EMBODIMENTS

Embodiments of the present invention will be described in detail below with reference to the drawings.

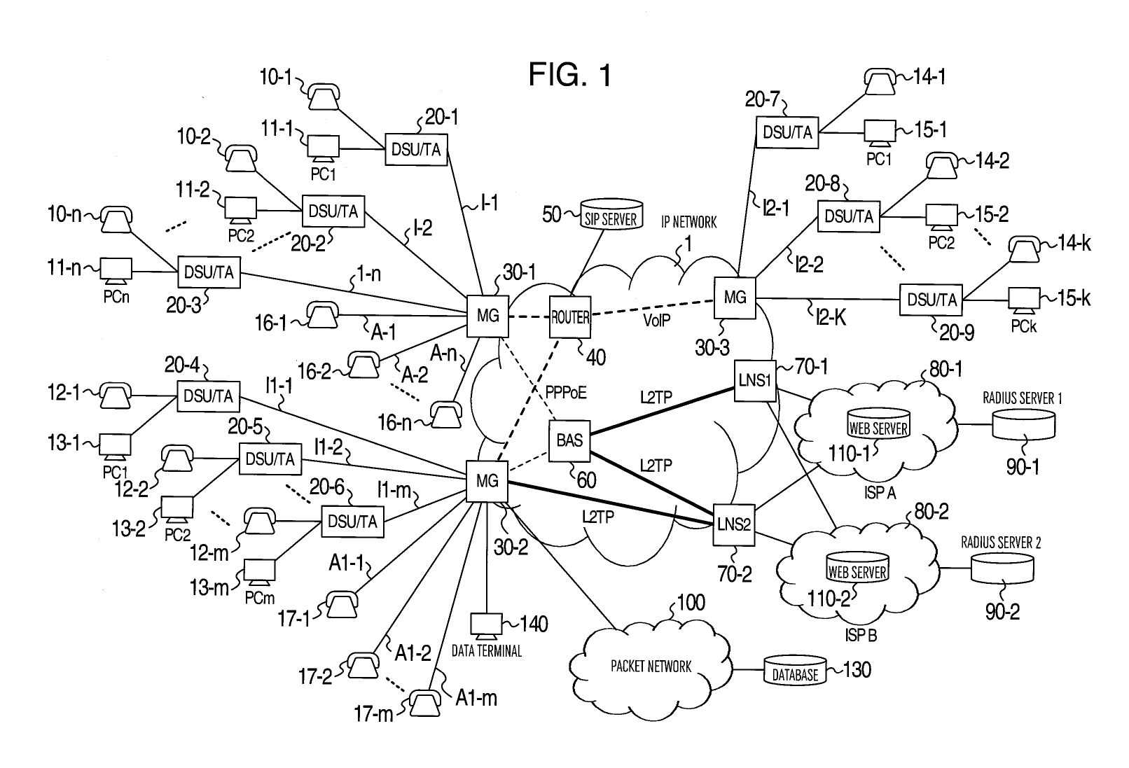

FIG. 1 is a diagram showing an example of one implementation configuration of an IP network.

The network includes multiple telephones 10-1-10-n, 12-1-12-m and 14-1-14-k and multiple PCs 11-1-11-n, 13-1-13-m, and 15-1-15-k that use ISDN lines, multiple telephones 16-1-16-n and 17-1-17-m that use analog lines, and a data terminal 140 that provides the packet switching service that is one of ISDN services. Each is connected to an IP network 1 via a media gateway (management device, MG) 30-1-30-3, and the MGs 30-1-30-3 are connected to LNS1 70-1 and LNS2 70-2 each owned by ISP A 80-1 and ISP B 80-2 that are Internet service providers. In addition, a packet network 100, which corresponds to the packet switching service, has the configuration of a network connected to the MG 30-2.

More specifically, the multiple telephones 10-1-10-n, 12-1-12-m and 14-1-14-k and multiple PCs 11-1-11-n, 13-1-13-m, and 15-1-15-k, which use ISDN lines, are connected to the MGs 30-1-30-3 via DSUs (Digital Service Unit), each of which has the function to receive signals from ISDN digital lines and convert the signals to a form processable by ISDN compatible devices such as a TA, or via TAs (Terminal Adapter) each of which digitizes signals, received from communication devices, so that various communication devices may be used on an ISDN digital line.

In the IP network 1, a router 40 that routes various packets and a BAS 60 that acts as a broadband access server are provided. To the router 40, a SIP server 50 that performs session control operations, such as the connection/disconnection of IP telephone sessions, via VoIP (Voice over Internet Protocol) and a RADIUS server (not shown), used for information inquiry, are connected.

A web server 110-1 and a web server 110-2 are provided in, and a RADIUS server 1 90-1 and a RADIUS server 2 90-2 used for authentication processing are connected to, ISP A 80-1 and ISP B 80-2 that are

Internet service providers. A database 130 is connected to the packet network 100 in which the packet switching service is performed.

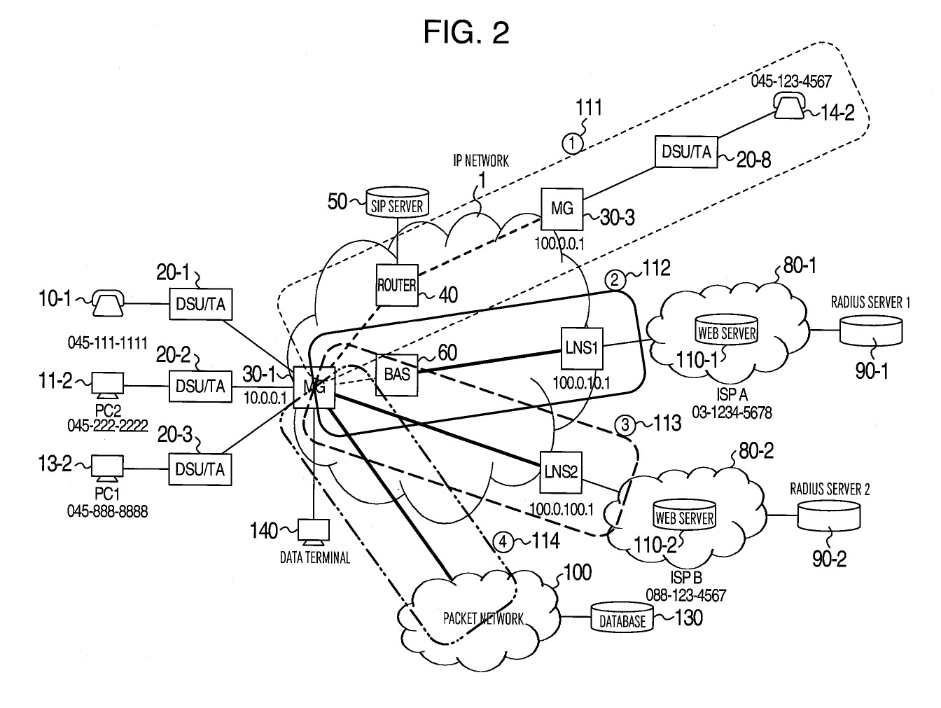

FIG. 2 is a diagram showing the general configuration of the network shown in FIG. 1.

A circled numeral 1 111 shown in FIG. 2 indicates the communication route used when the telephone 1 10-1 and the telephone 2 14-2 perform voice communication (VoIP (Voice over Internet Protocol)), a circled numeral 2 112 indicates the communication route 112 used when the PC2 11-2 and the web server 110-1 in the ISP A 80-1 perform data communication, a circled numeral 3 113 indicates the communication route 113 used when the PC1 13-2 and the web server 110-2 in the ISP B 80-2 perform data communication, and a circled numeral 4 114 indicates the communication route used when packet switching service users perform communication. The detail will be described later.

In FIG. 2, the character strings “xxx-xxx-xxxx” next to the telephone 1 10-1, PC2 11-2, PC1 13-2, ISP A 80-1, and ISP B 80-2 indicate their telephone numbers, and the character strings “xxx.xxx.x.x” next to the MGs 30-1-30-3, LNS1 70-1, and LSN2 70-2 indicate the IP addresses allocated to the terminals and the devices.

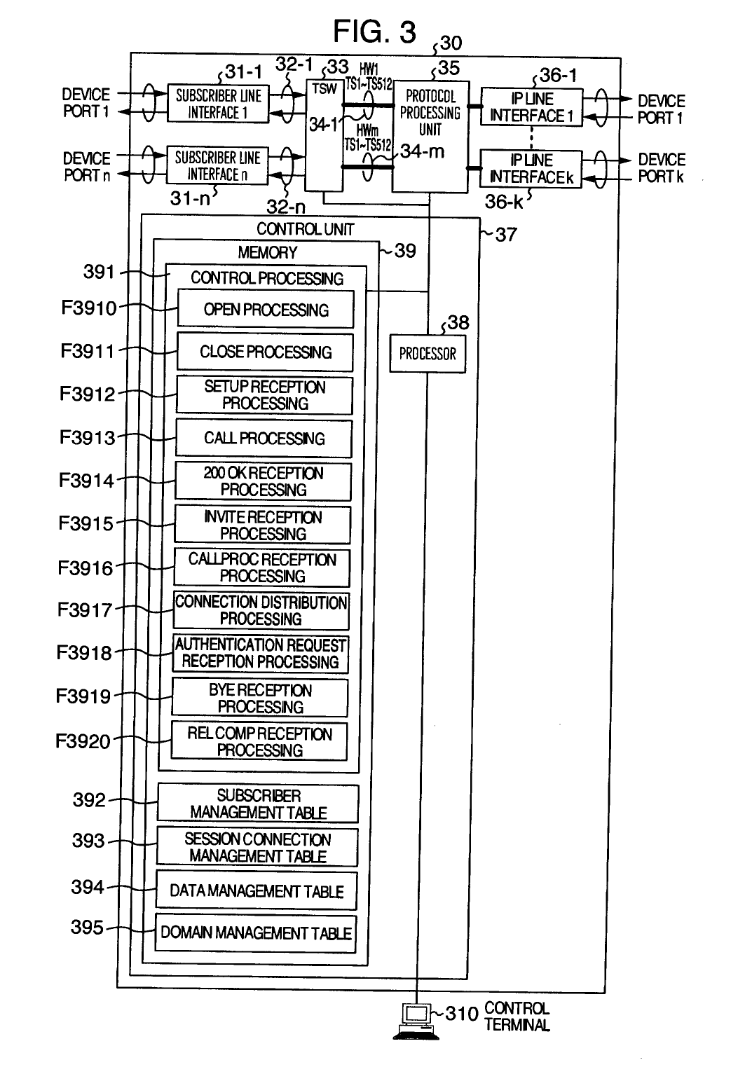

FIG. 3 is a block configuration diagram showing the main part of the media gateway (MG) 30.

The MG 30 comprises a processor 38 that controls the device operation; multiple subscriber line interfaces 31-1-31-n that connect to, and send and receive data to and from, the multiple telephones 10-1-10-n, 12-1-12-m, 14-1-14-k, 16-1-16-n, and 17-1-17-m, multiple PCs 11-1-11-n, 13-1-13-m, and 15-1-15-k, and the data terminal 140 that use the ISDN lines shown in FIG. 1 and FIG. 2; multiple subscriber HWs (High Way (time division bus)) 32-1-32-n for connecting data, received from the subscriber line interfaces, to a time division switch (hereinafter TSW) 33; the TSW 33 that terminates the subscriber HWs 32-1-32-n; multiple IP network side HWs (TS1-TS512, where TS means Time Slot) 34-1-34-m connected to a protocol processing unit 35; multiple IP line interfaces 36-1-36-n used for connecting to an IP network; and a memory 39.

A control terminal 310 is connected to the processor 38, and a maintenance engineer may use the control terminal 310 to control the device and to register and delete the information on the device.

The memory 39 includes control processing 391 as the software composed of multiple control processing modules such as open processing F3910, close processing F3911, SETUP reception processing F3912, call processing F3913, 200 OK reception processing F3914, INVITE reception processing F3915, CALLPROC reception processing F3916, connection distribution processing F3917, authentication request reception processing F3918, BYE reception processing F3919, and REL COMP reception processing F3920. The memory 39 also includes a subscriber information management table 392, a session connection management table 393, a data management table 394, and a domain management table 395.

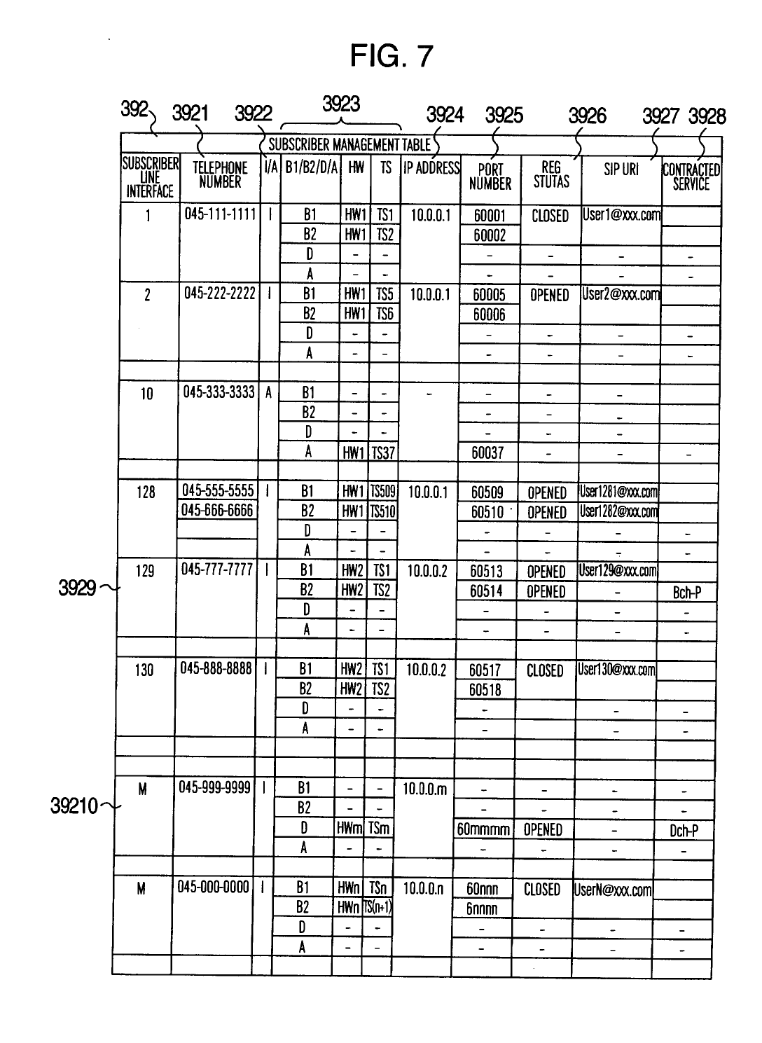

The detailed processing of the control processing 391 included in the memory 39 of a control unit 37 will be described later in detail. The subscriber management table 392 includes the information on the subscribers and so on (information on the type of line to which a terminal used by a subscriber is connected, setting information on the time division switch of the MG management device to which the terminal is connected, and service information on the terminal user). As shown in FIG. 7, the following information is registered and updated for management in this table: subscriber's telephone number 3921, I/A 3922 indicating whether an ISDN line is used or an analog line is used, various types of information 3923 such as B1/B2/D/A that is information indicating what packet the subscriber uses and HW and TS permanently allocated to the subscriber, IP address 3924 and port number 3925 used by the MG 30, REG STATUS 3926 indicating whether the subscriber line is available for use (open/close status), SIP URI 3927 that is identification information when SIP is used, and contract service 3928 indicating, for example, whether the subscriber is using the packet switching service. The use of the subscriber management table 392 will be described later in detail.

As indicated in the subscriber management table 392, 3929.39210 shown in FIG. 7, the subscriber's contract service 3928 is Bch-P 3929 and Dch-P 39210. This information indicates the service is the packet switching service and that this service is different from the ISDN line service or the analog line service. The MG 30-1 checks if the packet switching service is used and, if so, sends data to the packet network. Although not described in the embodiments, the MG 30-1 checks the contract service 3928 of the subscriber management table 392,3929.39210 shown in FIG. 7 and sends data to the packet network 100.

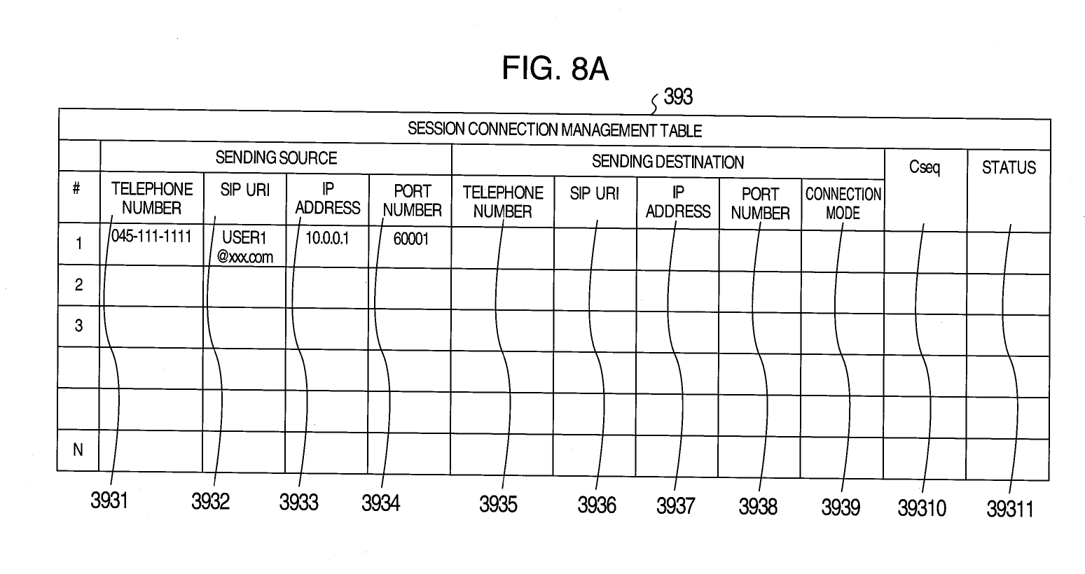

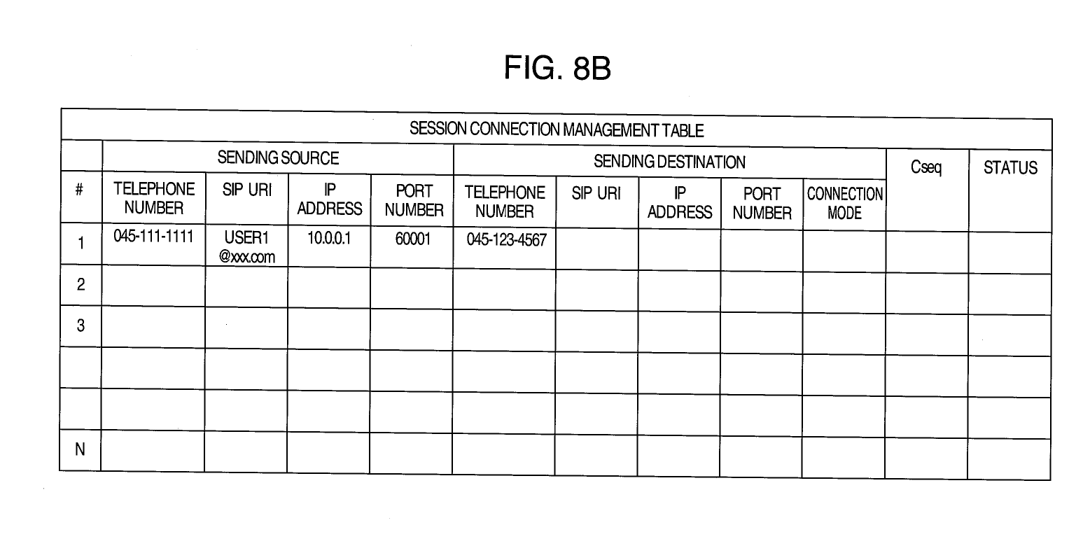

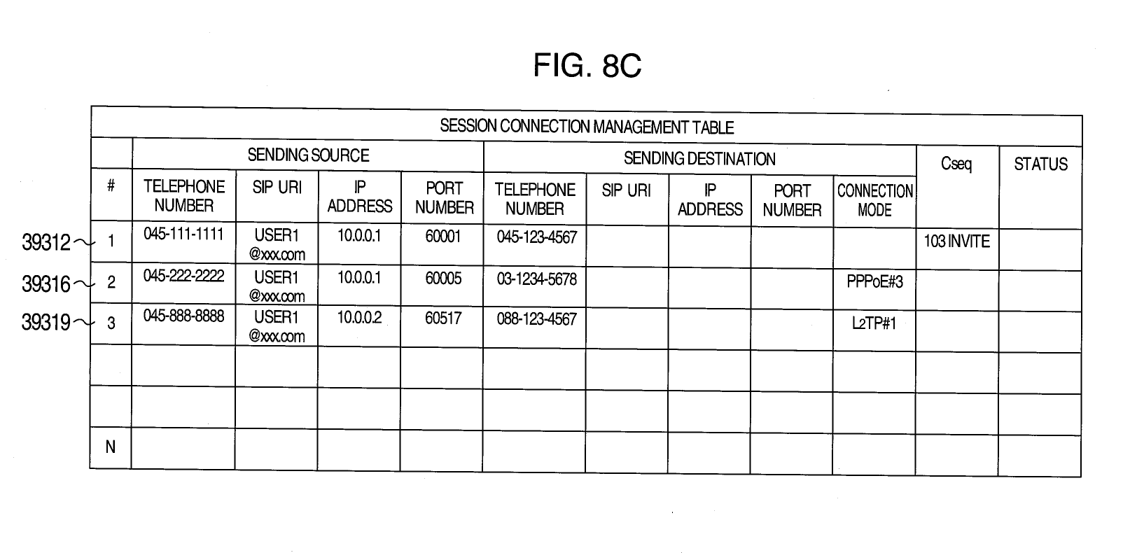

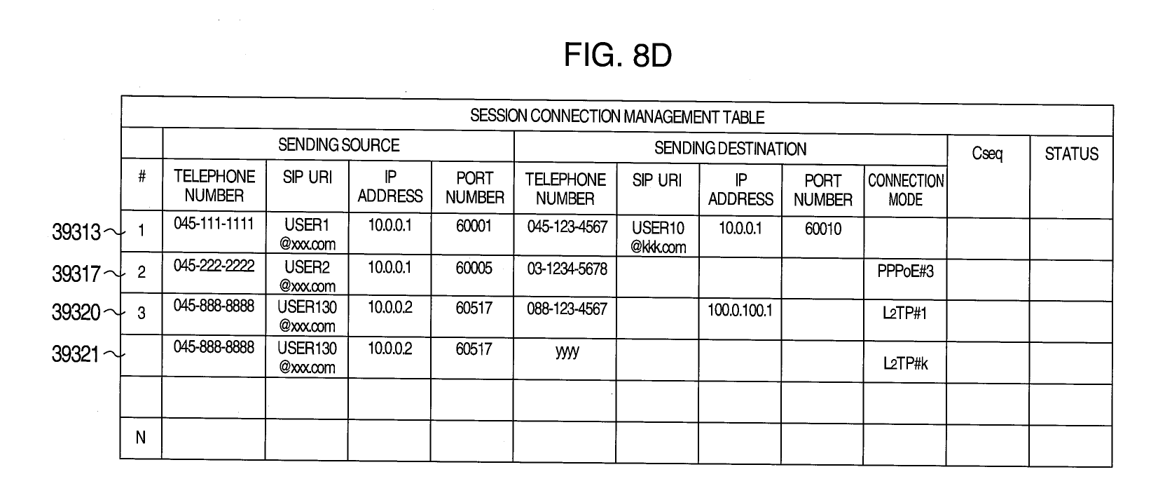

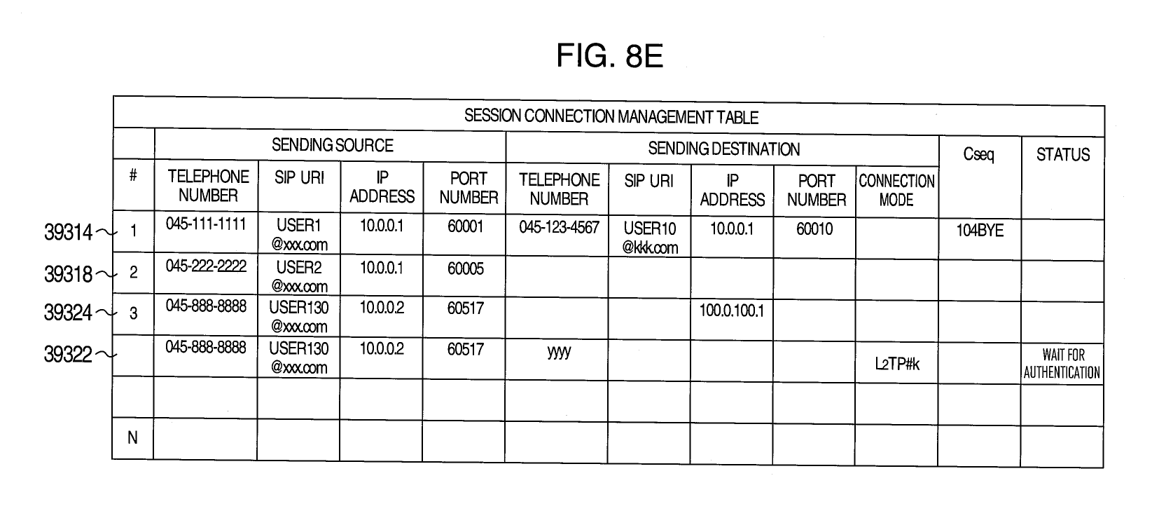

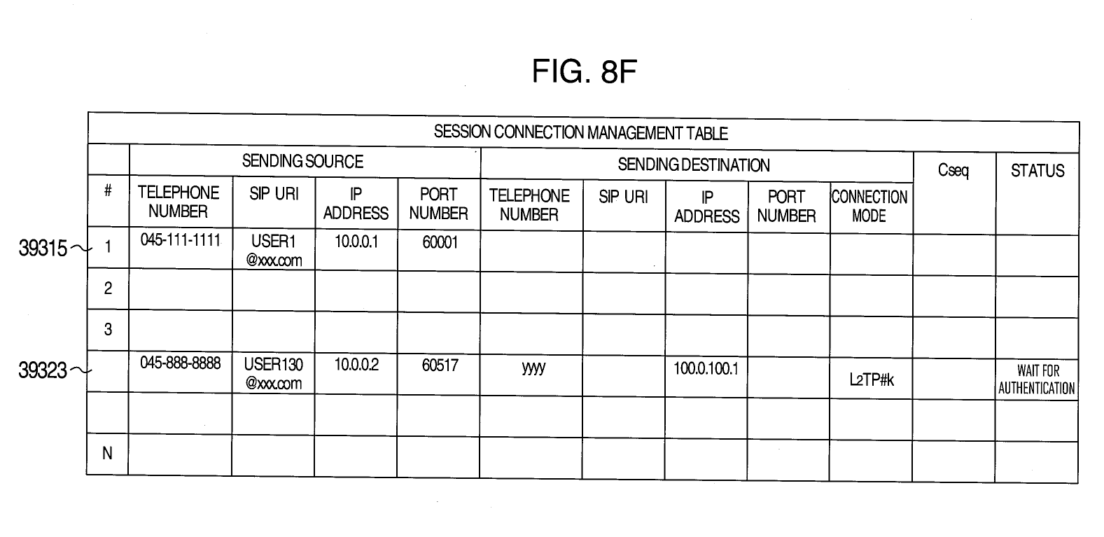

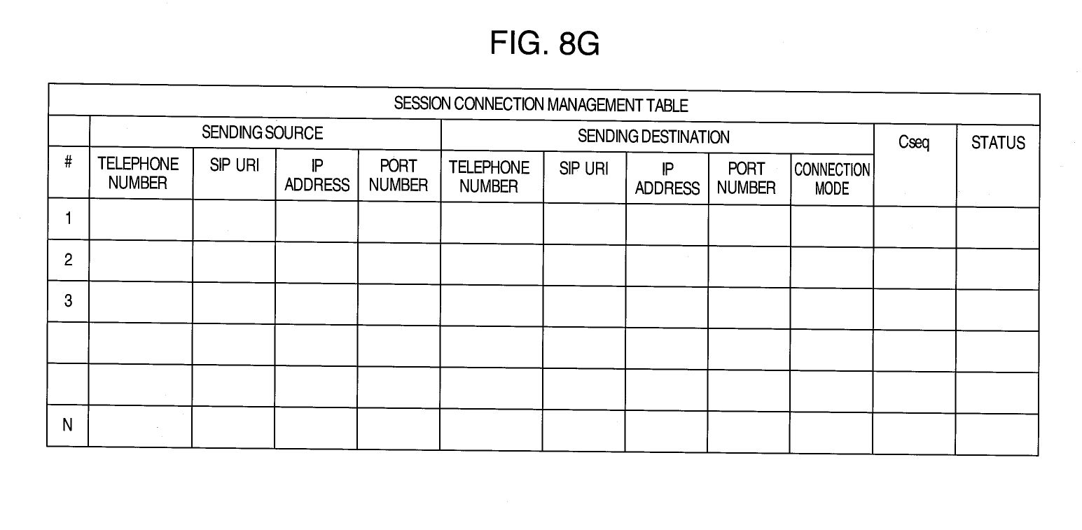

The session connection management table 393 is a table in which information on session connections is stored. As shown in FIGS. 8A-8G, the following information is registered and updated for management in this table: sending source telephone number 3931, SIP URI 3932 that is identification information used when communication is performed via SIP, information on IP address 3933 and port number 3934 that is used, connection destination telephone number 3935, SIP URI 3936 that is identification information used when communication is performed via SIP, IP address 3937, port number 3938 that is used, information on connection mode 3939 such as information indicating that the connection destination is connected via PPPoE or L2TP, Cseq 39310 that is a command sequence for identifying a session connection message when communication is performed via SIP, and Status 39311. The use of the session connection management table 393 will be described later in detail.

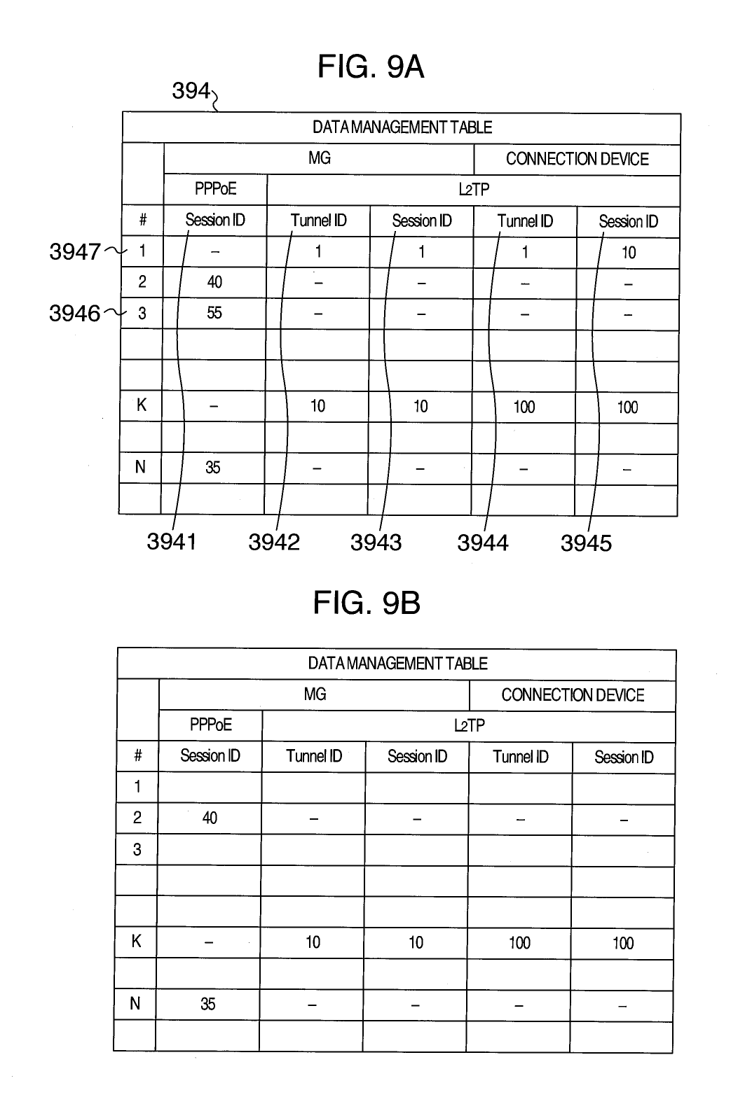

The data management table 394 is a table in which session information, generated when a PPPoE session is established, is stored. As shown in FIGS. 9A and 9B, the following information is registered and updated for management in this table: session ID 3941 used when a PPPoE session is established, tunnel ID 3942 and session ID 3943 of the MG 30 when L2TP tunneling is formed, and tunnel ID 3944 and session ID 3945 of the connection device with which L2TP tunneling is formed. The use of the data management table 394 will be described later in detail.

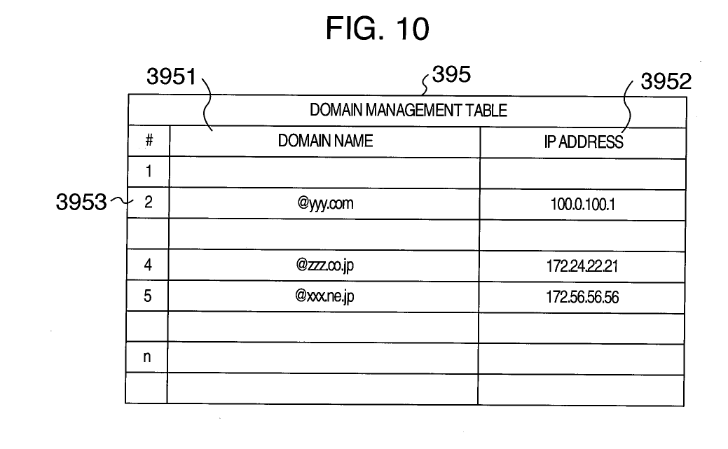

The domain management table 395 is a table in which information on Internet service providers is stored. As shown in FIG. 10, the following information is registered and managed in this table: domain name 3951 determined for each Internet service provider and IP addresses 3952 of LNSs 70-1 and 70-2 owned by the Internet service provider. The use of the domain management table 395 will be described later in detail.

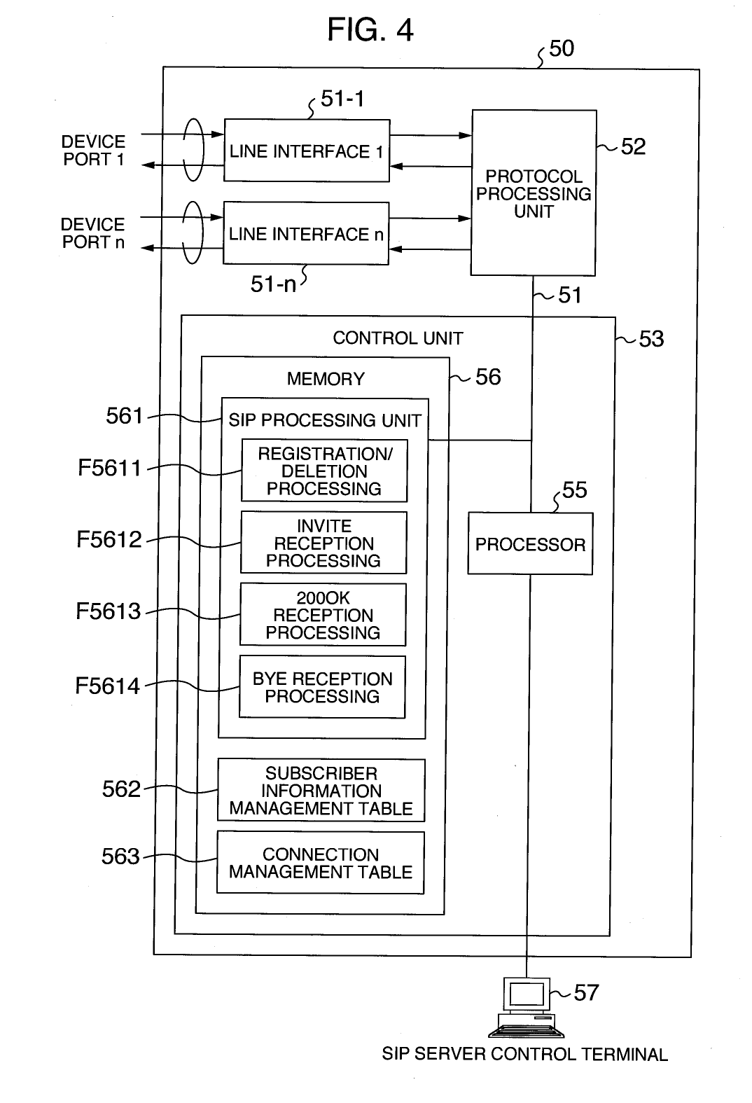

FIG. 4 is a block configuration diagram showing the main part of the SIP server 50. The SIP server 50 comprises a processor 55 that controls the server, line interfaces 51-1 and 51-n via which data is sent and received, a protocol processing unit 52 connected to the line interfaces 51-1 and 51-n, a memory 56, and an internal bus 51. A memory 56 of a control unit 53 includes a SIP processing unit 561, a subscriber information management table 562, and a connection management table 563. The processor 55 uses the subscriber information management table 562 and the connection management table 563 to execute the processing of the SIP processing unit 561.

The processor 55 is connected to a control terminal 57. The maintenance engineer may use the control terminal 57 to control the device and register and delete information.

The SIP processing unit 561 includes processing modules for registration/deletion processing F5611, INVITE reception processing F5612, 200 OK reception processing F5613, and BYE reception processing F5614. The processing modules will be described later in detail.

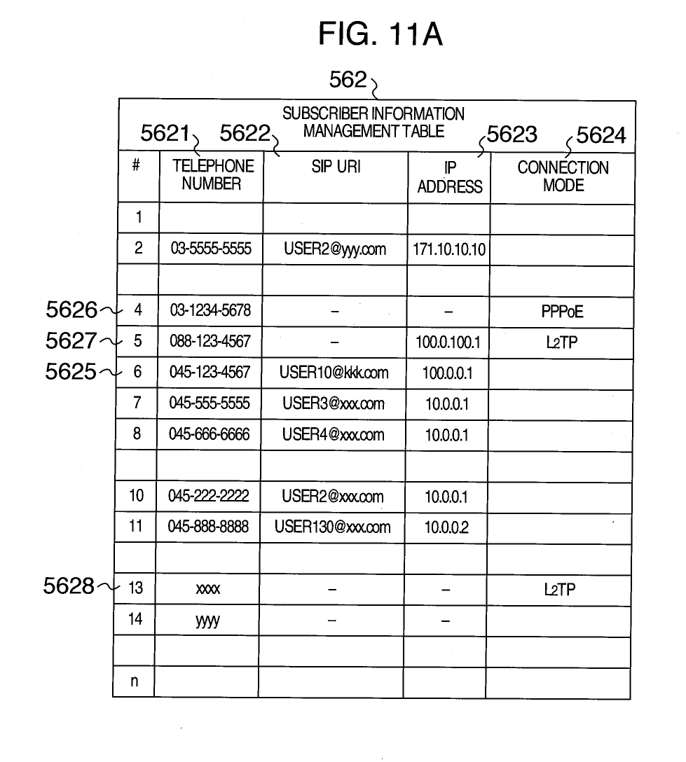

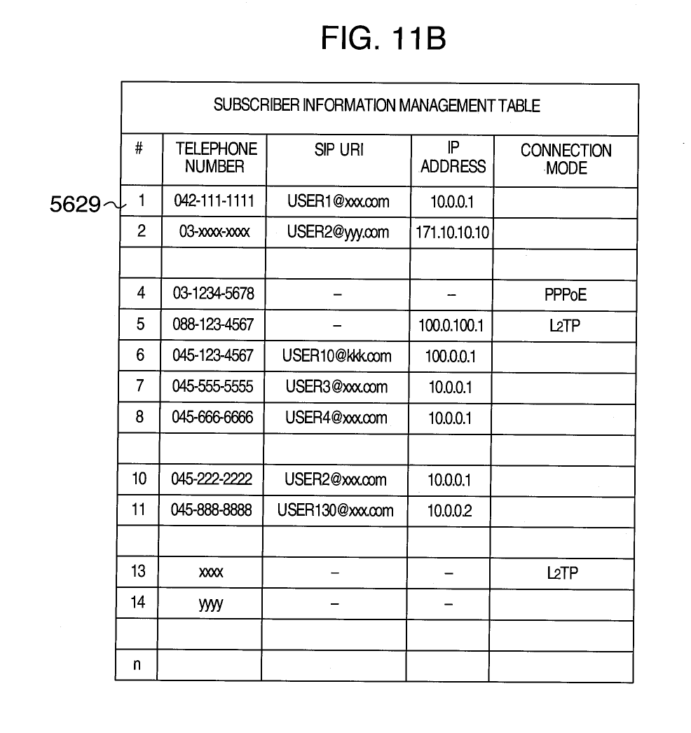

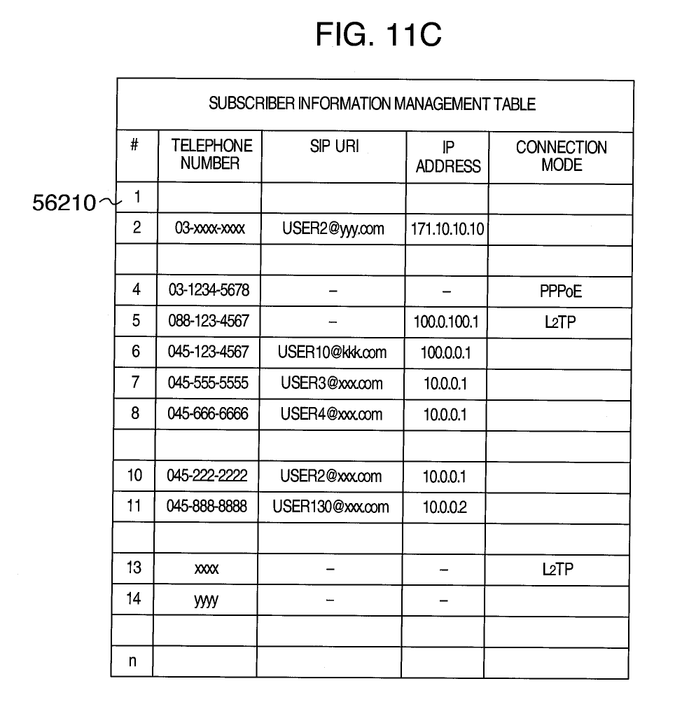

As shown in FIGS. 11A, 11B, and 11C, the subscriber information management table 562 manages information on the subscribers who have requested to register information. More specifically, the following information is registered and updated in this table: telephone number 5621 of a subscriber, SIP URI 5622 that is terminal identification information, IP address 5623 of the connection destination device, and connection mode 5624 that indicates the method in which a connection is made to a registered user or to the ISP. The use of the subscriber information management table 562 will be described later in detail.

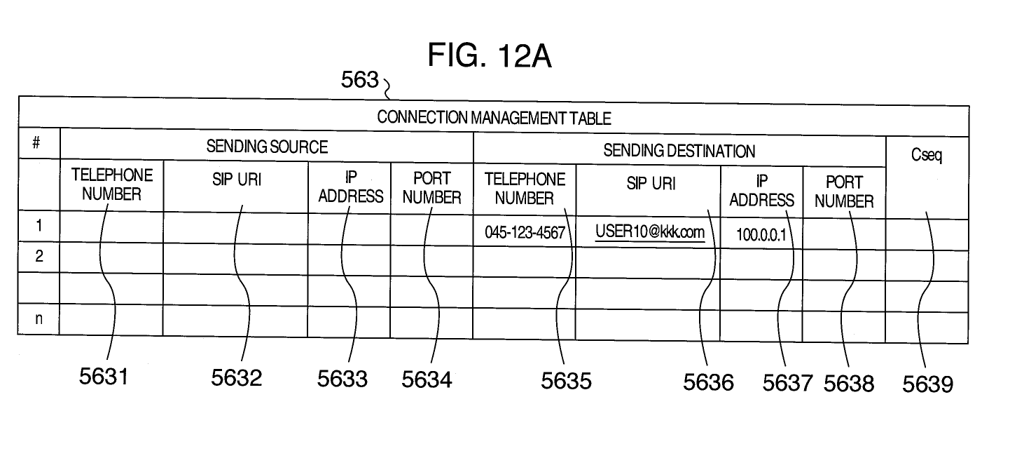

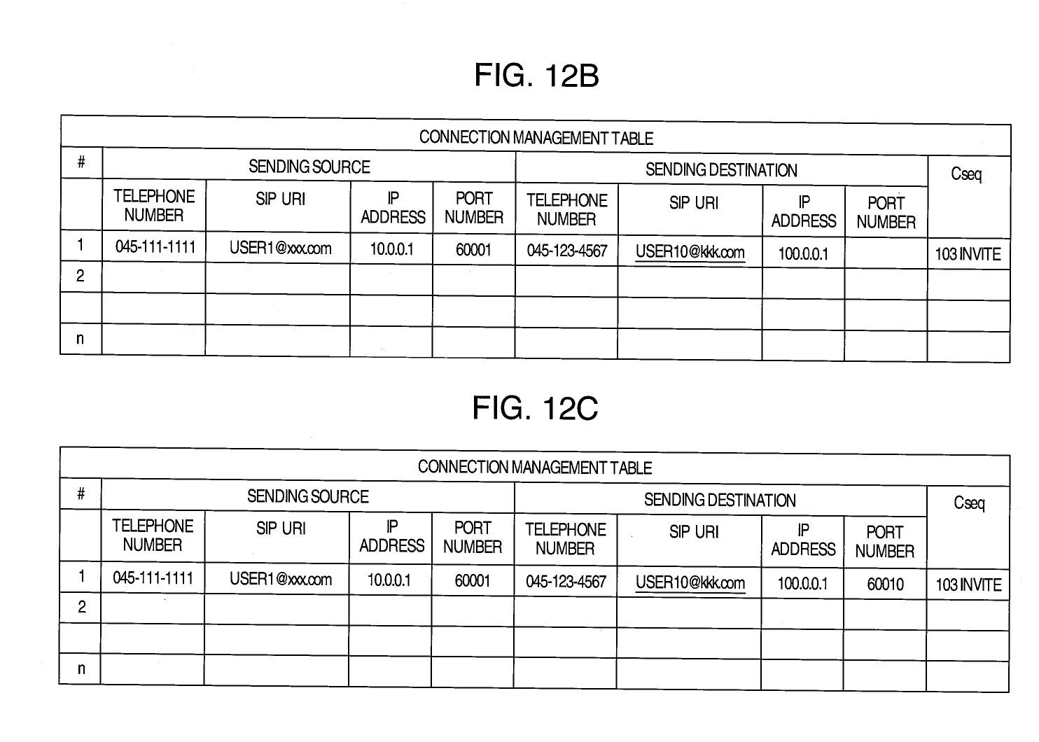

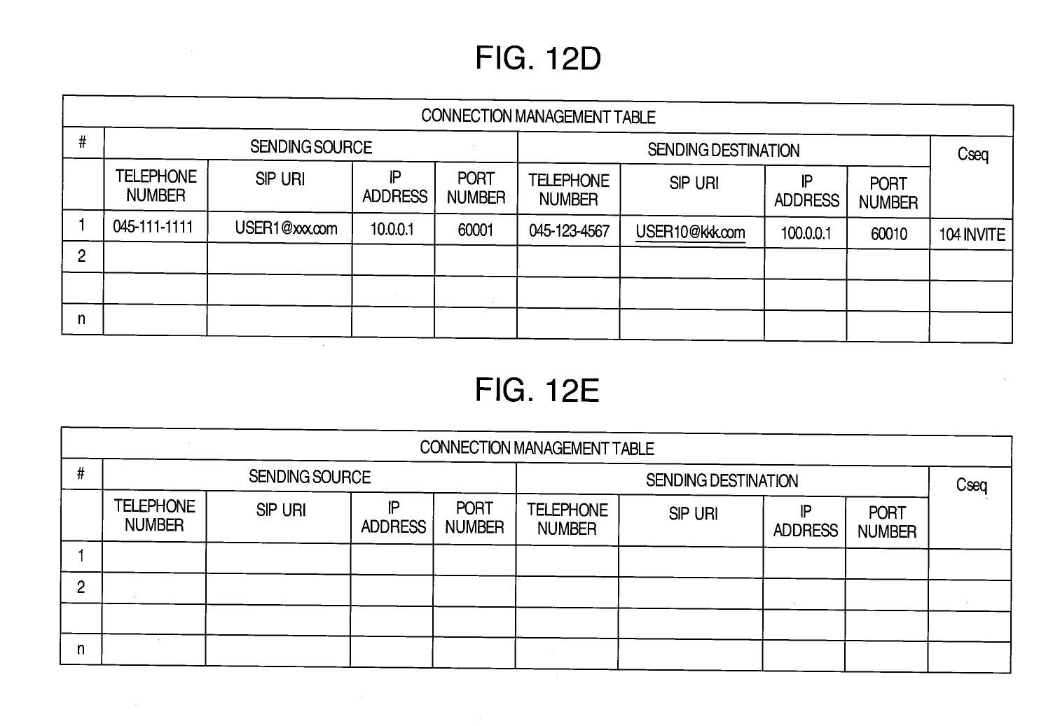

As shown in FIGS. 12A-12E, the connection management table 563 manages information on session-connected terminals. The following information is registered and updated for management in this table: source telephone number 5631, SIP URI 5632 that is identification information used in communication via SIP, information on IP address 5633 and port number 5634, destination telephone number 5635, SIP URI 5636, information on IP address 5637 and port number 5638, and command sequence CSeq 5639 that is message identification information in a SIP message. The use of the connection management table 563 will be described later in detail.

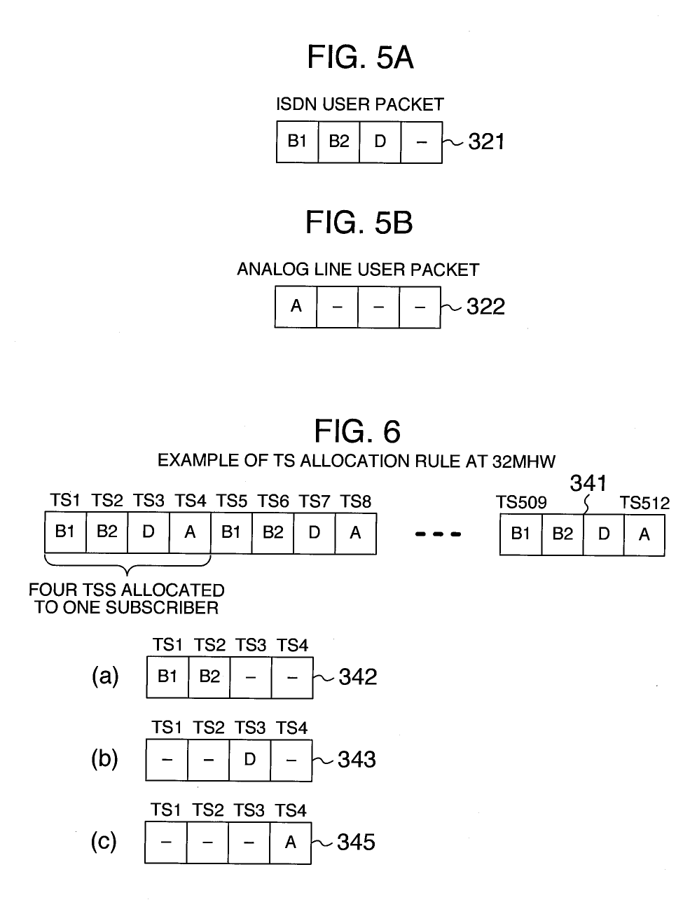

FIGS. 5A and 5B are diagrams showing an example of the allocation of subscriber HWs 32-1-32-n shown in FIG. 3. As shown in FIG. 5A, ISDN line users are allocated two B-channel packets and one D-channel packet. Those packets are sent via the subscriber HWs 32-1-32-n and terminated by the TSW 33. FIG. 5B is a diagram showing the allocation for an analog line user. The packet is terminated by the TSW 33 shown in FIG. 3. The I/A 3922 in the subscriber management table 392 shown in FIG. 7 is referenced to determine which line type is used, ISDN line or analog line.

FIG. 6 is a diagram showing an example of the rule for allocating TSs of HWs 34-1-34-m distributed by the TSW 33 in the MG 30 shown in FIG. 3. In this embodiment, four TSs are always allocated to one subscriber. Four time-slots are allocated to two B-channel packets, one D-channel packet, and an analog line. Because TS1-TS512 are allocated to one HW in the case of 32 MHW, 128 users may be accommodated.

As shown in FIG. 6(a), an ISDN line user, who uses only the B1 and B2 channels, use TS1 and TS2. In this case, TS3 and TS4 remain unused.

As shown in FIG. 6(b), an ISDN line user, who uses only the D channel, uses only TS3. In this case, TS1, TS2, and TS4 remain unused.

As shown in FIG. 6(c), an analog line user uses only TS4. In this case, TS1-TS3 remain unused.

The status described above is managed based on the information in the subscriber management table 392, and whether to use HW and TS is determined for each user.

Although the use of HWs is fixed in the present invention, it is also possible that the information in the subscriber management table 392 is checked to see if there are free HWs and, if there are, those free HWs are used in order to use HWs efficiently.

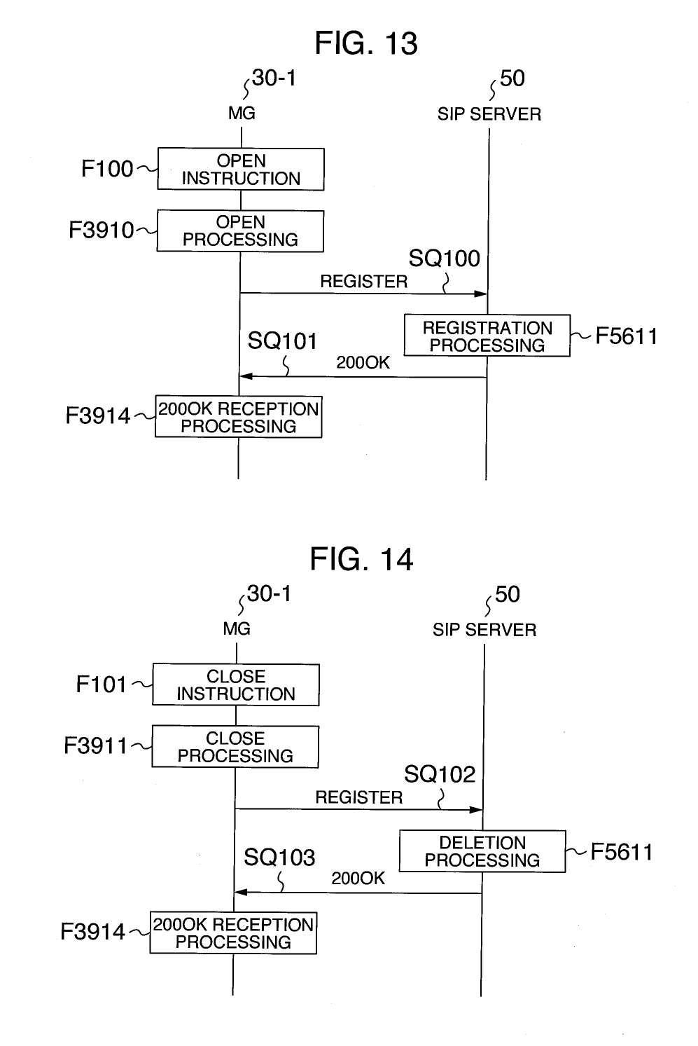

FIG. 13 is a diagram showing the sequence in which, when the maintenance engineer issues a new user information registration command or a line open command from the control terminal 310 shown in FIG. 3, the MG 30 sends a subscriber information registration message to the SIP server 50 to register the subscriber information in the database of the SIP server 50.

FIG. 14 is a diagram showing the sequence in which, when the maintenance engineer issues a command to delete information on a withdrawn user or a line close command, such as user information on temporary line closing, from the control terminal 310 shown in FIG. 3, the MG 30 sends a subscriber information deletion message to the SIP server 50 to delete the subscriber information from the database of the SIP server.

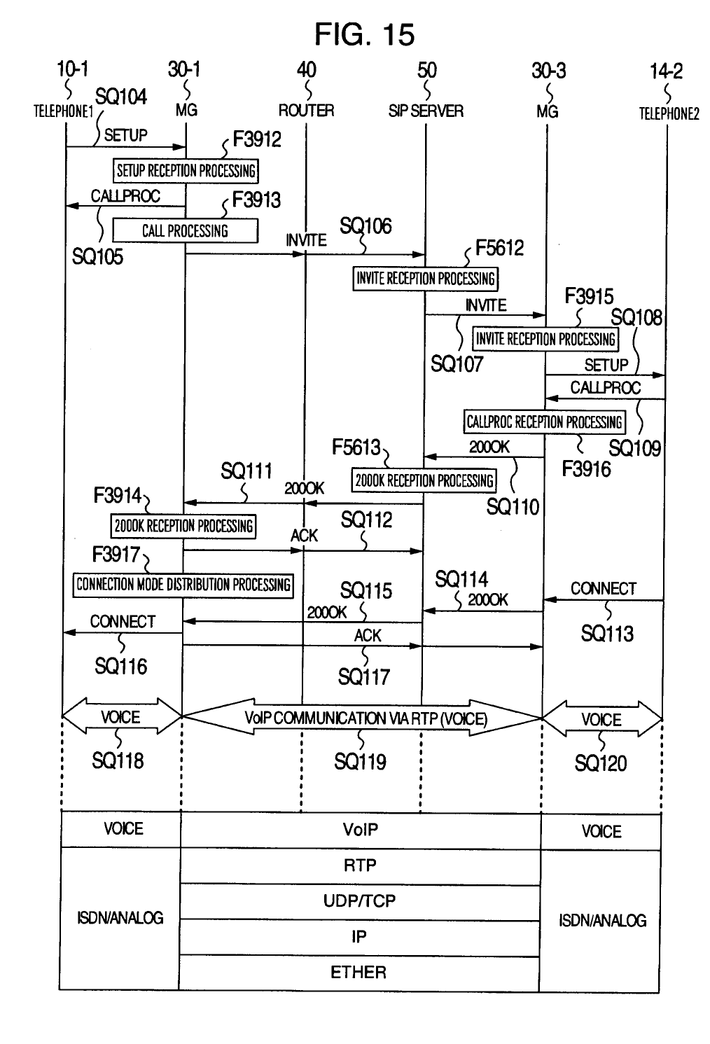

FIG. 15 is a diagram showing the sequence and the protocol stack for a telephone 1 10-1 and a telephone 2 14-2 to perform the VoIP (Voice over Internet Protocol) communication (voice call) via RTP (Real-time Transport Protocol).

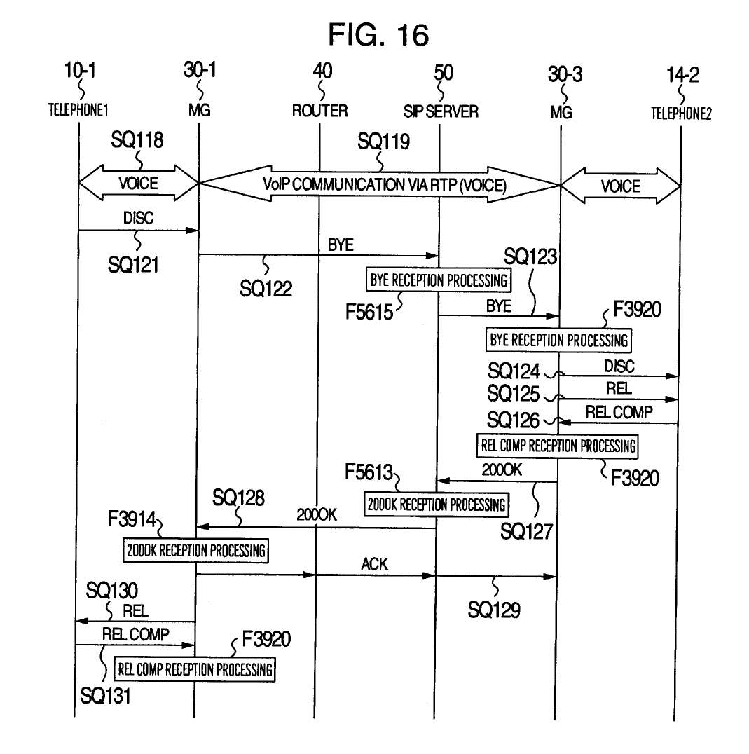

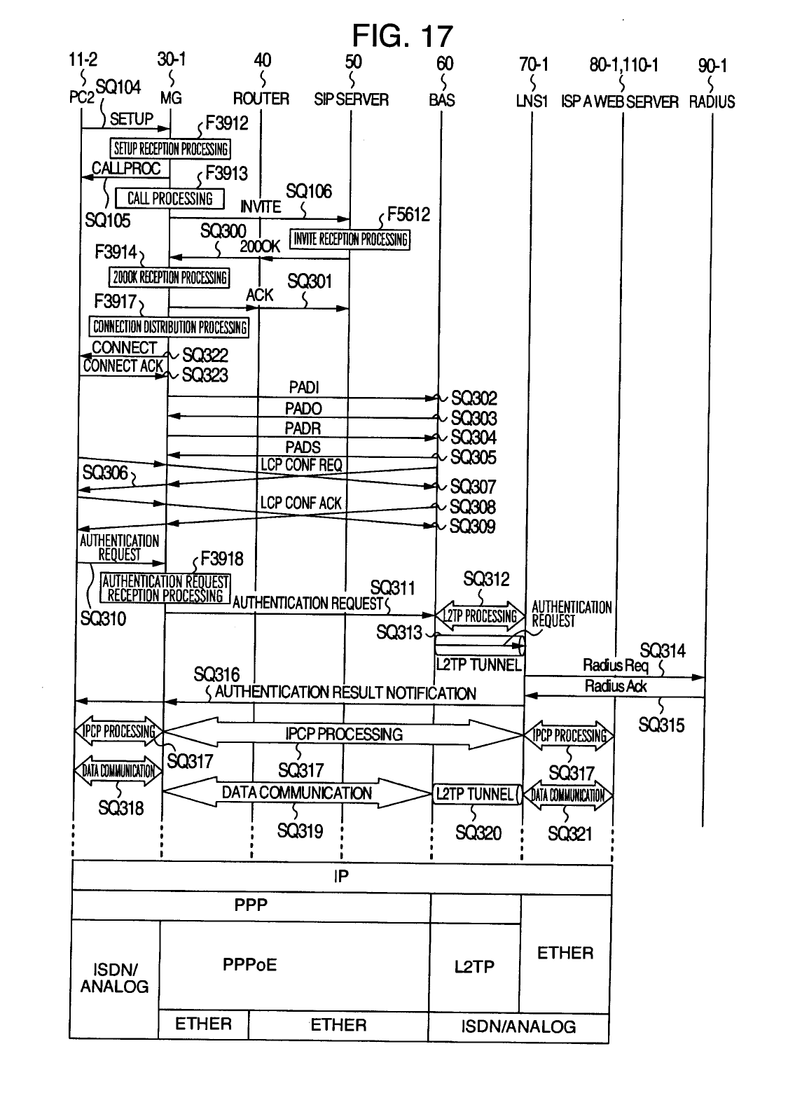

FIG. 16 is a diagram showing the sequence for disconnecting the VoIP communication (voice call) between the telephone 1 10-1 and the telephone 2 14-2.

### FIRST EMBODIMENT

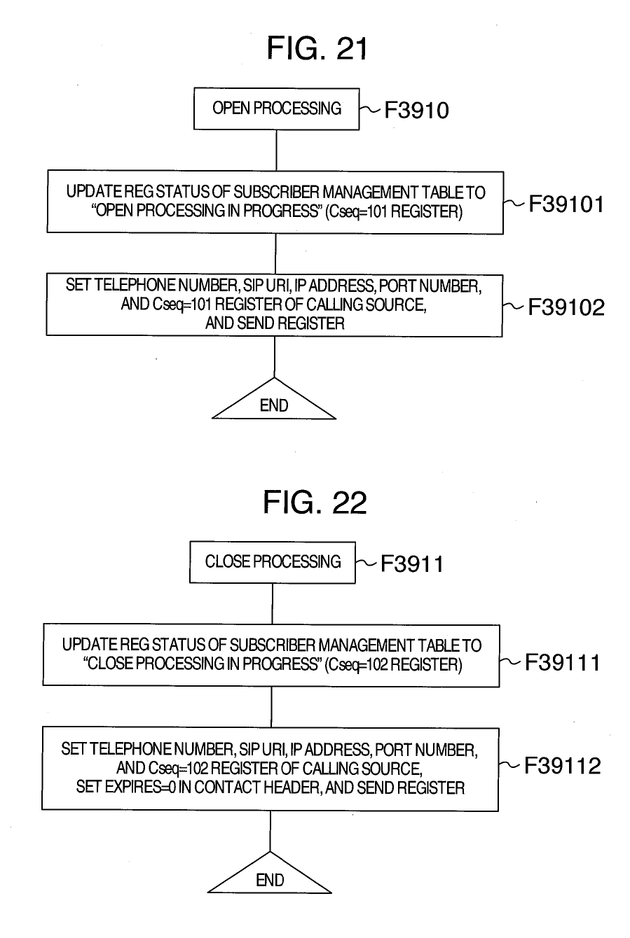

The following describes the processing operation of the MG 30 and the SIP server 50 in a first embodiment with reference to the communication sequences in FIG. 13 to FIG. 16 and the flowcharts in FIG. 21 to FIG. 35.

First, the following describes the processing operation of the MG 30-1 and the SIP server 50 that is performed when subscriber information is registered in, or deleted from, the SIP server 50.

To register information on new subscribers or to specify the various settings, the maintenance engineer enters a command via the control terminal 310 shown in FIG. 3. The maintenance engineer enters not only subscriber information but also an open instruction for making the line connectable or a close instruction for temporarily closing a line for certain reasons on the user side.

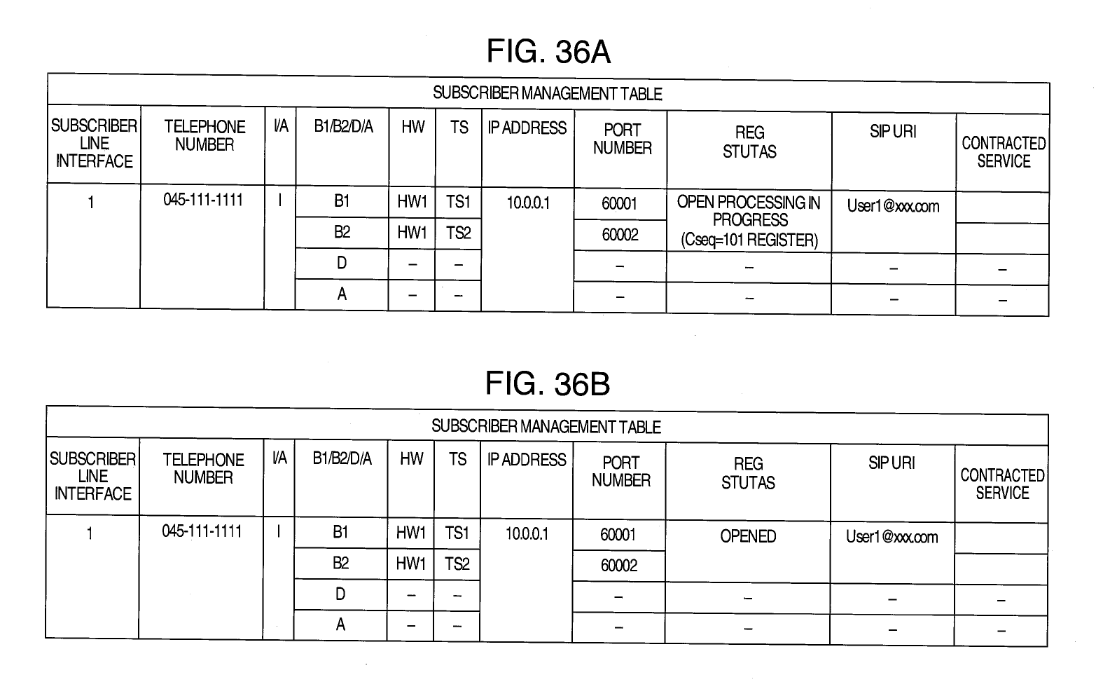

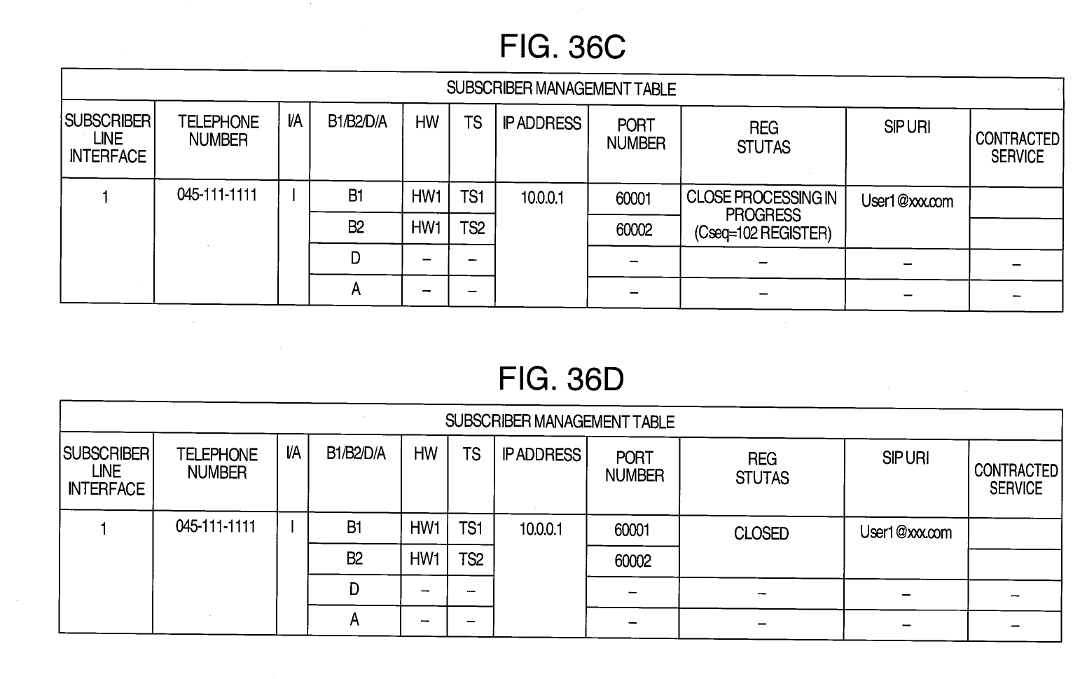

First, when the open instruction command is issued to open the line (F100), the MG 30-1 updates REG STATUS 3926 to “open processing in progress” (Cseq=101 REGISTER) as shown in the subscriber management table 392 in FIG. 36A according to the flow of the open processing F3910 in FIG. 21 (F39101). In the present invention, which of the two channels, channel B1 or channel B2, is to be selected is not defined.

After the update processing is completed, the information registered in the subscriber management table 392, that is, calling user telephone number 3921, SIP URI 3927 that is the identification information on the communication via SIP, and the IP address 3924 and the port number 3925 used by the MG 30-1, is added to the SIP message. After that, using the command sequence Cseq (Cseq=101 REGISTER) that is identification information on the SIP message registered in REG STATUS 3926, MG 30-1 sends the REGISTER packet (SQ100), which is a subscriber information registration message, to the SIP server 50 (F39102).

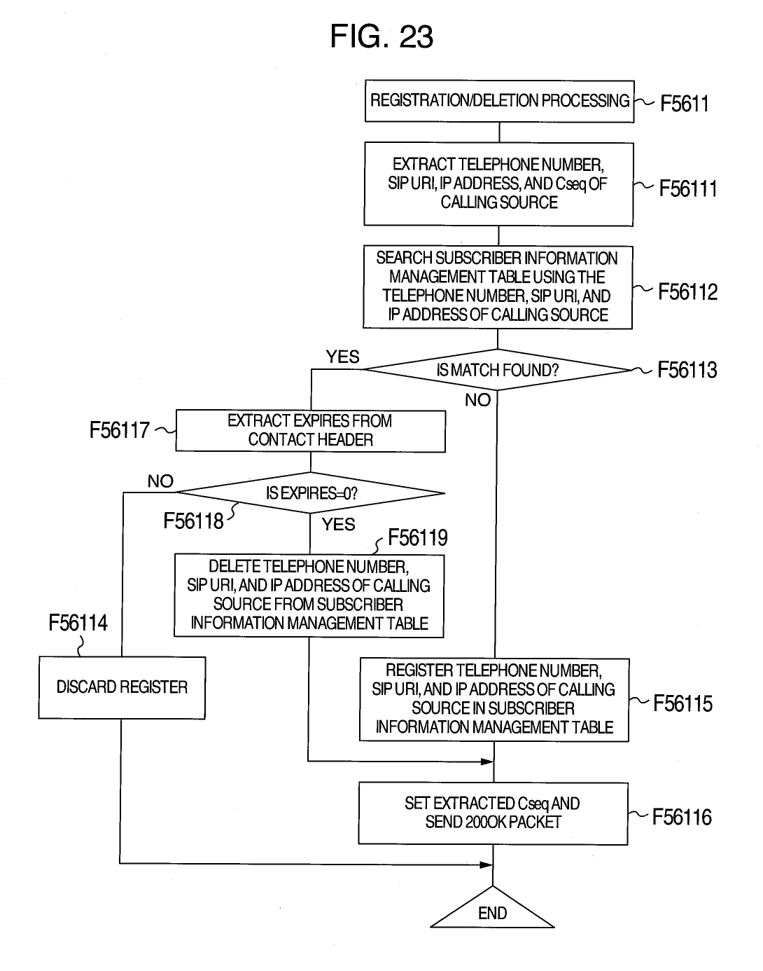

When the REGISTER packet SQ100 is received, the SIP server 50 performs the flow of the registration/deletion processing F5611 shown in FIG. 23. That is, the SIP server 50 extracts the calling source telephone number, SIP URI that is the identifier in the communication via SIP, IP address, as well as the command sequence Cseq that is the identification information on the SIP message (F56111), and searches the subscriber information management table 562, shown in FIG. 11A, using the calling source telephone number, SIP URI that is the identifier in the communication via SIP, and the IP address (F56112).

Next, the SIP server checks if the extracted information is already registered and matches the registered information F56113 and, if the matching information is already registered, performs the processing that will be described later. If there is no matching information, the extracted information composed of the telephone number, SIP URI, IP address, and Cseq, is registered in the subscriber information management table shown in FIG. 11B F56115, 562-1. After the information is registered, the extracted Cseq is set in the 200 OK packet that is a SIP message indicating the completion of registration and the 200 OK packet SQ101 is sent to the calling source (F56116).

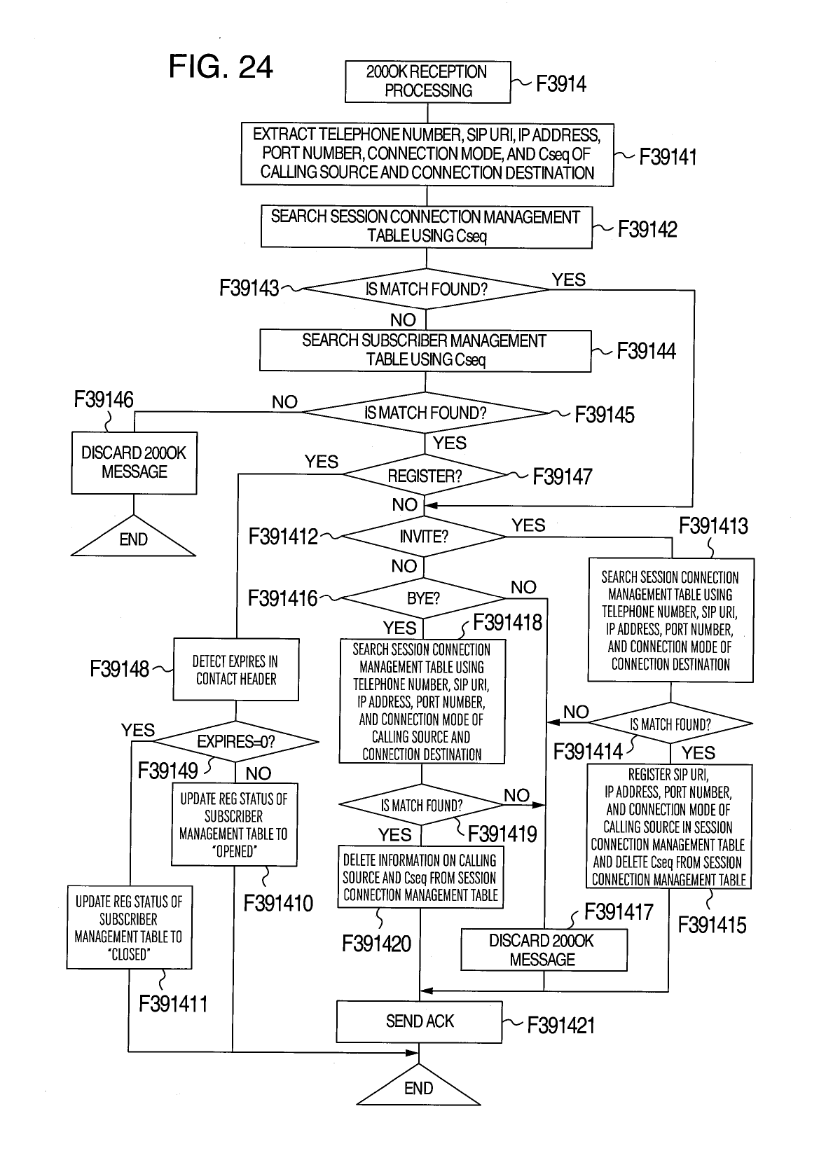

When the 200 OK packet SQ101 that is a registration completion notification is received, the MG 30-1 performs the processing according to the flow of the 200 OK reception processing F3914 shown in FIG. 24. That is, from the received 200 OK packet SQ101, the MG 30-1 extracts the calling source and connection destination telephone numbers, SIP URI that is the identification information used in the SIP processing, IP address, port number, connection mode, and Cseq (F39141) and searches the session connection management table 393, shown in FIGS. 8A-8G, using the command sequence Cseq that is the identification information on the SIP message (F39142). The MG 30-1 checks if the information is already registered F39143 and, if there is matching information, control is passed to F391412 in the flow. If there is no matching information, the MG 30-1 searches the subscriber management table, shown in FIG. 7, using the command sequence Cseq that is the identification information on the SIP message (F39144) and checks if the result indicates a match (F39145). If the search result indicates that there is no matching information, the received 200 OK packet SQ101 is discarded (F39146); if the search result indicates that there is matching information, the MG 30-1 checks if the command sequence Cseq that is identification information on the SIP message is the one for REGISTER (F39147). If the command sequence Cseq is not the one for REGISTER, the processing that will be described later is performed. If the 200 OK packet SQ101 is the one for REGISTER, the MG 30-1 extracts ‘expires’ from the CONTACT header of the SIP message (F39148) and checks if the value of expires is 0 (F39149). If the value is not 0, REG STATUS 3926 is updated to ‘opened’ as shown in the subscriber management table 392 in FIG. 36B (F391410). If the value is 0, the processing that will be described later is performed. After the above steps are performed, the MG 30-1 completes the subscriber information registration processing for the SIP server 50.

Next, the following describes the subscriber information deletion processing. When the close instruction F101 is received, the MG 30-1 performs the processing according to the flow of the close processing F3911 shown in FIG. 22. That is, the MG 30-1 updates REG STATUS 3926 to “close processing in progress” (Cseq=102 REGISTER) as shown in the subscriber management table 392 in FIG. 36C F39111. When the updating is completed, the information registered in the subscriber management table 392, that is, the calling source telephone number 3921, SIP URI 3927 that is the identification information on communication via SIP, IP address 3924 and port number 3925 that is used, and the command sequence Cseq (102 REGISTER) that is the identification information on the SIP message registered in REG STATUS 3926, is added, 0 is set in expires, and the REGISTER packet SQ102 that is the subscriber information deletion message is sent to the SIP server 50 (F39112).

When the REGISTER packet SQ102 is received, the SIP server 50 performs the processing according to the flow of the registration/deletion processing F5611 shown in FIG. 23. In the description below, the description of the processing included in the description of the subscriber information registration processing, is omitted and the description begins at F56113 in the flow where the information matches the registration information.

In F56113 in the flow, if the search result indicates that there is matching information, the SIP server extracts expires from the SIP message (F56117) and checks if the extracted value is 0 (F56118). If the checking result indicates that the value is not 0, the REGISTER message SQ102 is discarded (F56114); if the checking result indicates that the value is 0, the extracted SIP URI, IP address, and telephone number are deleted (F56119) as shown in the subscriber information table 562, 562-2 shown in FIG. 11C. After the deletion is completed, the extracted Cseq is set in the 200 OK packet that is the SIP message indicating that the deletion is completed, and the 200 OK packet SQ103 is sent to the calling source (F56116).

When the 200 OK packet SQ103 indicating that the deletion is completed is received, the MG 30-1 performs the processing according to the flow of the 200 OK reception processing F3914 shown in FIG. 24. The description of the processing included in the description of the registration processing is omitted here, and the description begins at F39148 in the flow. If expires in the CONTACT header of the extracted SIP message is 0, REG STATUS 3926 is updated to “closed” (F391411) as shown in the subscriber management table 392 in FIG. 36D.

When the above processing is finished, the subscriber information deletion processing performed by the MG 30-1 for the SIP server 50 is completed. Next, the following describes the processing operation of the MG 30-1 and the SIP server 50 that is performed before the telephone 1 10-1 and the telephone 2 14-2 start communication via RTP (Real-time Transport Protocol) (VoIP (Voice over Internet Protocol) communication) according to the communication sequence shown in FIG. 15.

To start a telephone call to the telephone 2 14-2, the telephone 1 10-1 sends the SETUP message SQ104 that is a call placing request message.

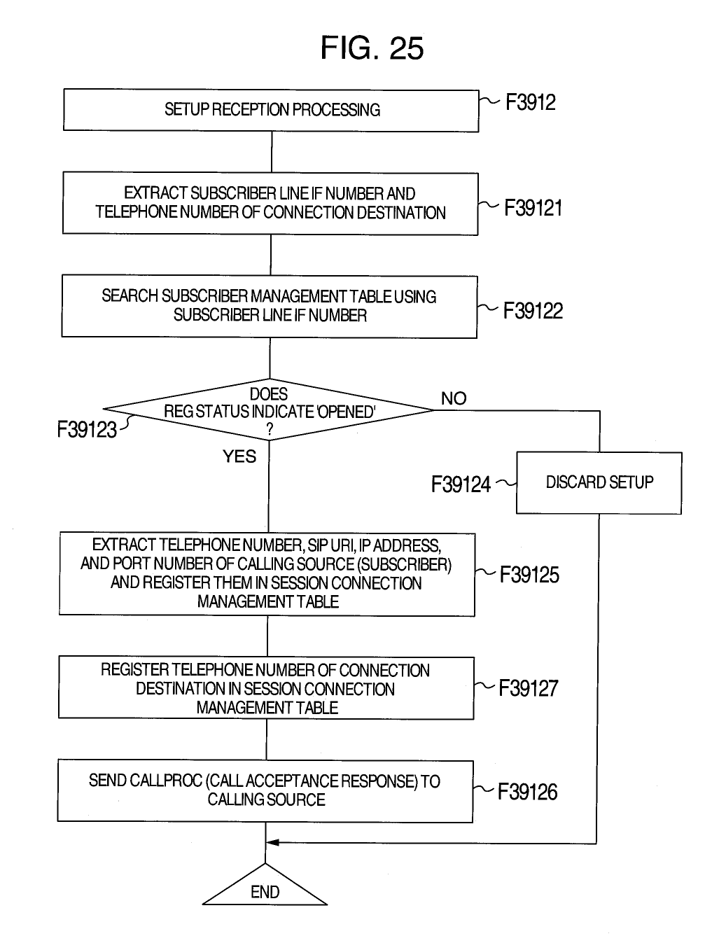

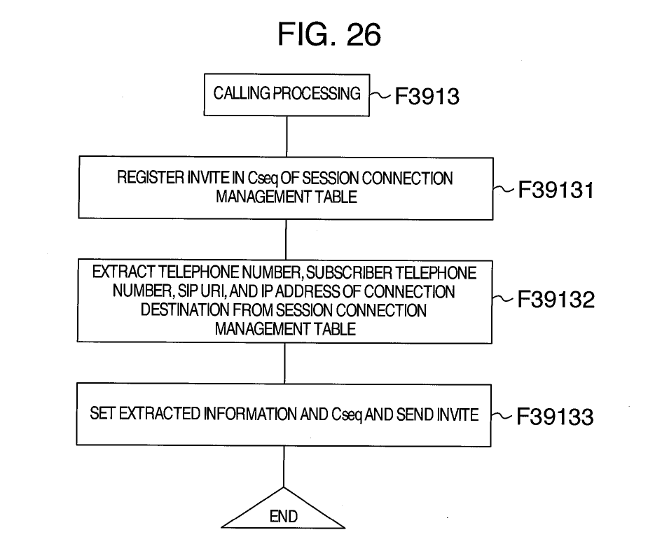

When the call placing request message SETUP SQ104 is received, the MG 30-1 performs the processing for converting the message, received from the line network, to a form processable by the SIP protocol according to the flow of the SETUP reception processing F3912 shown in FIG. 25. First, the MG 30-1 extracts the subscriber line IF number (number of line from which message was received) and the connection destination telephone number (F39121) and searches the subscriber management table 392, shown in FIG. 7, using the subscriber line IF number (number of line from which message was received) (F39122). After that, the MG 30-1 checks if REG STATUS 3926 of the subscriber management table 392, shown in FIG. 7, includes “opened” (F39123). If the status is not “opened” as shown in the subscriber management table 392 in FIGS. 36 A, C, and D, the SETUP message SQ104 is discarded F39124; on the other hand, if the status is “opened” as shown in REG STATUS 3926 of the subscriber management table 392 in FIG. 36B, the calling source (subscriber) telephone number, SIP URI, IP address, and the port number are extracted from the subscriber management table 392 shown in FIG. 7 and registered in the session connection management table 393 shown in FIG. 8A (F39125). In addition, the telephone number of the connection destination extracted from the SETUP message SQ104 is registered in the session connection management table 393 shown in FIG. 8B (F39127), and CALLPROC SQ105 indicating the acceptance of the call placing request message is sent to the calling source (subscriber)(F39126). After CALLPROC is sent, the MG 30-1 performs the processing according to the flow of the calling processing F3913 shown in FIG. 26. That is, the MG 30-1 registers “103 INVITE” in Cseq that is the identification information on the SIP message as shown in Cseq 39310 of the session connection management table 393 in FIG. 8C F39131, extracts the telephone number of the connection destination, telephone number of the calling source (subscriber), SIP URI, and IP address from the session connection management table 393 shown in FIG. 8C (F39132), moves the SETUP message SQ104, received from the telephone 1 10-1, to the INVITE packet SQ106, which is a session connection request used by the SIP protocol, using the extracted information and Cseq (103 INVITE) that is the identification information on the registered SIP message, and. sends the generated INVITE packet to the SIP server 50 (F39133).

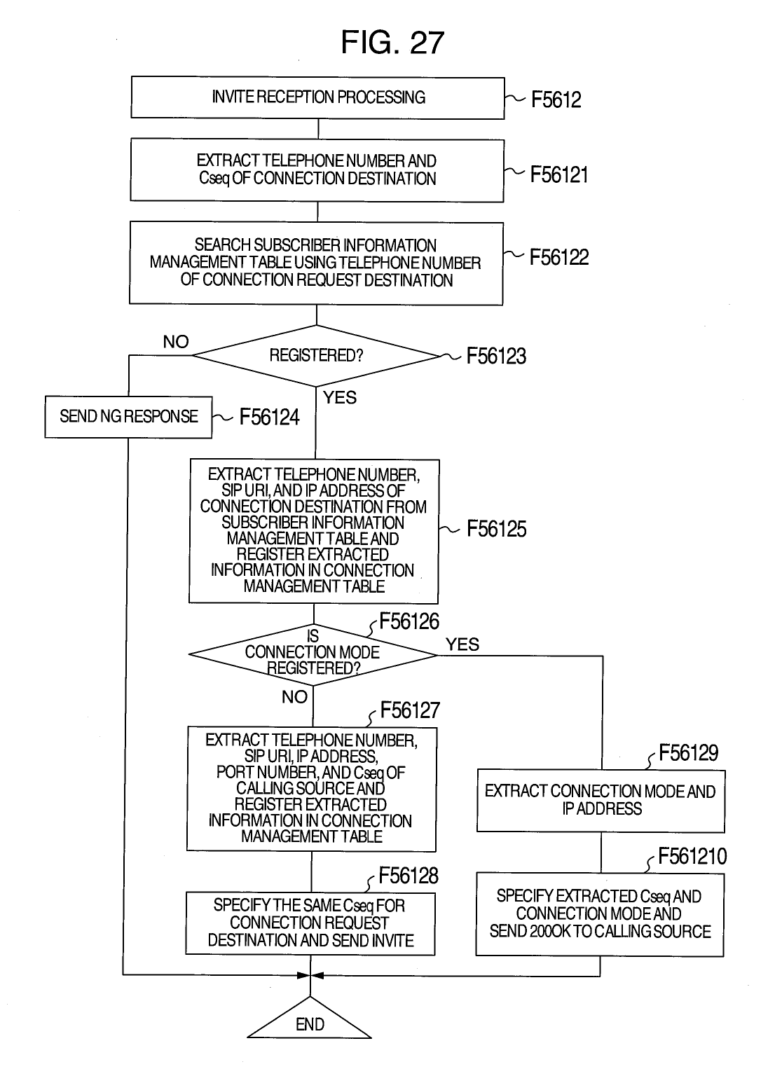

When the INVITE packet SQ106 that is a session connection request is received, the SIP server 50 performs the processing according to the flow of the INVITE reception processing F5612 shown in FIG. 27. That is, the SIP server 50 extracts the telephone number of the connection destination and the command sequence Cseq that is the identification information on the SIP message (F56121) and searches the subscriber information management table 562, shown in FIGS. 11A-11C, using the telephone number of the connection destination. If the information on the connection destination is not registered in the SIP server 50, the SIP server 50 cannot process the session connection request and, so, sends the NG response to the calling source to indicate that the connection to the other party cannot be made (F56124). If the information on the connection destination is registered as shown in the subscriber information management table 562, 5625 shown in FIG. 11A, the SIP server 50 extracts the telephone number, SIP URI, and IP address of the connection destination from the subscriber information management table 562, 5625 shown in FIG. 11A and registers the extracted information in the connection management table 563, 56310 shown in FIG. 12A (F56125). In addition, the SIP server 50 checks if the connection mode 5624 is registered in the subscriber information management table 562 shown in FIG. 11A (F56126). If the connection mode is not registered as shown in the subscriber information management table 562, 5625 shown in FIG. 11A, the SIP server 50 performs the processing recognizing that the communication is not the data communication but the voice communication. From the received INVITE packet SQ106, the SIP server 50 extracts SIP URI that is the identification information on SIP communication of the calling source, IP address, port number, and Cseq that is the command sequence indicating the identification information on the SIP message and registers the extracted information as shown in the connection management table 563, 56311 shown in FIG. 12B (F56127). The processing that is performed when the connection mode is registered will be described in detail in the second embodiment.

When the registration is completed (F56127), the SIP server 50 sends the INVITE packet SQ107, which is a session connection request message, to the connection destination using Cseq (103 INVITE) that is the command sequence indicating the identification information on the same SIP message (F56128).

The connection mode managed in the table is the information used to determine which is sent, voice or data, and at the same time used to specify the connection method of the connection destination, for example, voice communication or data communication via PPPoE or L2TP. That is, the connection mode indicates the information on the communication condition on the network. It is assumed that this connection mode information is registered in the SIP server 50 in advance. If the connection mode is not registered or the connection mode is registered as RTP, the INVITE message that is a session connection request is sent to the connection destination as in the ordinary SIP serve. The operation that is performed when the connection mode is registered will be described in detail in the second embodiment.

Although stored in the SIP server 50 in this embodiment, the connection mode information may also be managed by the database in some other system or by the MG 30.

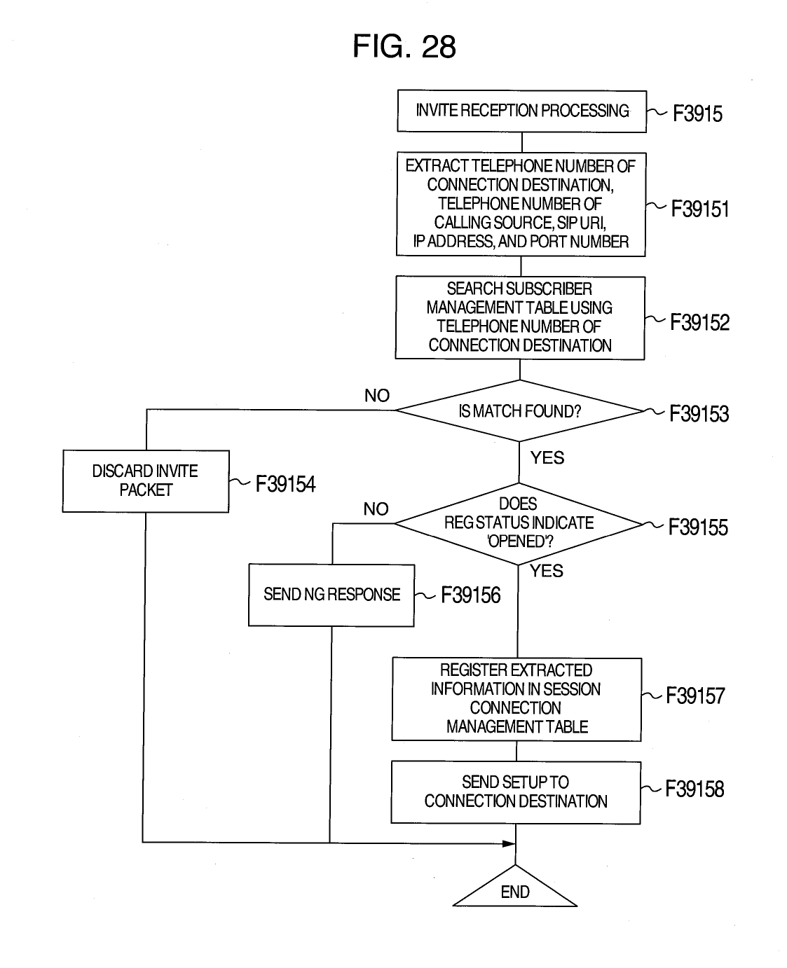

When the INVITE packet SQ107 that is a session connection request message is received, the MG 30-3 performs the INVITE reception processing F3915 shown in FIG. 28. That is, the MG 30-3 extracts the telephone number of the connection destination and the telephone number of the calling source, SIP URI, IP address, and port number from the received INVITE packet SQ107 (F39151) and searches the subscriber management table 392, shown in FIG. 7, using the telephone number of the connection destination (F39152). The MG 30-3 checks if the search result indicates that there is a matching telephone number (F39153). If there is not a matching telephone number, the INVITE packet SQ107 is discarded because the user is not a user served by the MG 30-3 (F39154); if there is a matching telephone number, the MG 30-3 determines that it is serving the user and, after that, checks REG STATUS 3926 of the subscriber management table 392 shown in FIG. 7 to see if the status is ‘opened’ (F39155). If the status is not ‘opened’, the MG 30-3 sends the NG response message to the calling source to indicate that the connection cannot be made (F39156). If the status is ‘opened’, the status indicates that the connection may be established. In this case, the MG 30-3 registers the extracted information in the session connection management table 393 shown in FIGS. 8A-8G (F39157), moves the session connection request INVITE message SQ107, which is the SIP message, to a message processable on the line network, and sends the SETUP message SQ108, which is the call placing request message, to the connection destination (F39158).

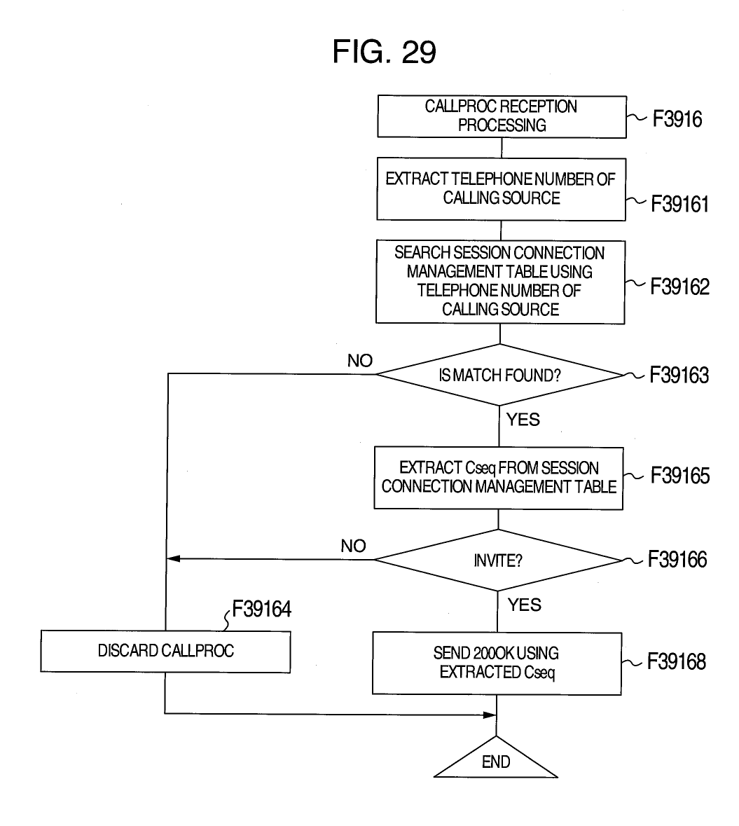

When CALLPROC SQ109 that is a response to the call placing message SETUP SQ108 is received, the MG 30-3 performs the processing according to the flow of the CALLPROC reception processing F3916 shown in FIG. 29. That is, the MG 30-3 extracts the telephone number of the calling source (F39161) and searches the session connection management table 393 shown in FIGS. 8A-8G (F39162). If the search result indicates that there is not a matching telephone number, the CALLPROC is discarded (F39164); if there is a matching telephone number, the MG 30-3 extracts the command sequence Cseq that is the identification information on the SIP message from the session management table (F39205). The MG 30-3 checks to see if the extracted Cseq is the one for INVITE (F39166). If Cseq is not the one for INVITE, CALLPROC is discarded F39164; if Cseq is the one for INVITE, 200 OK SQ110 is sent using the extracted Cseq (103 INVITE) (F39168).

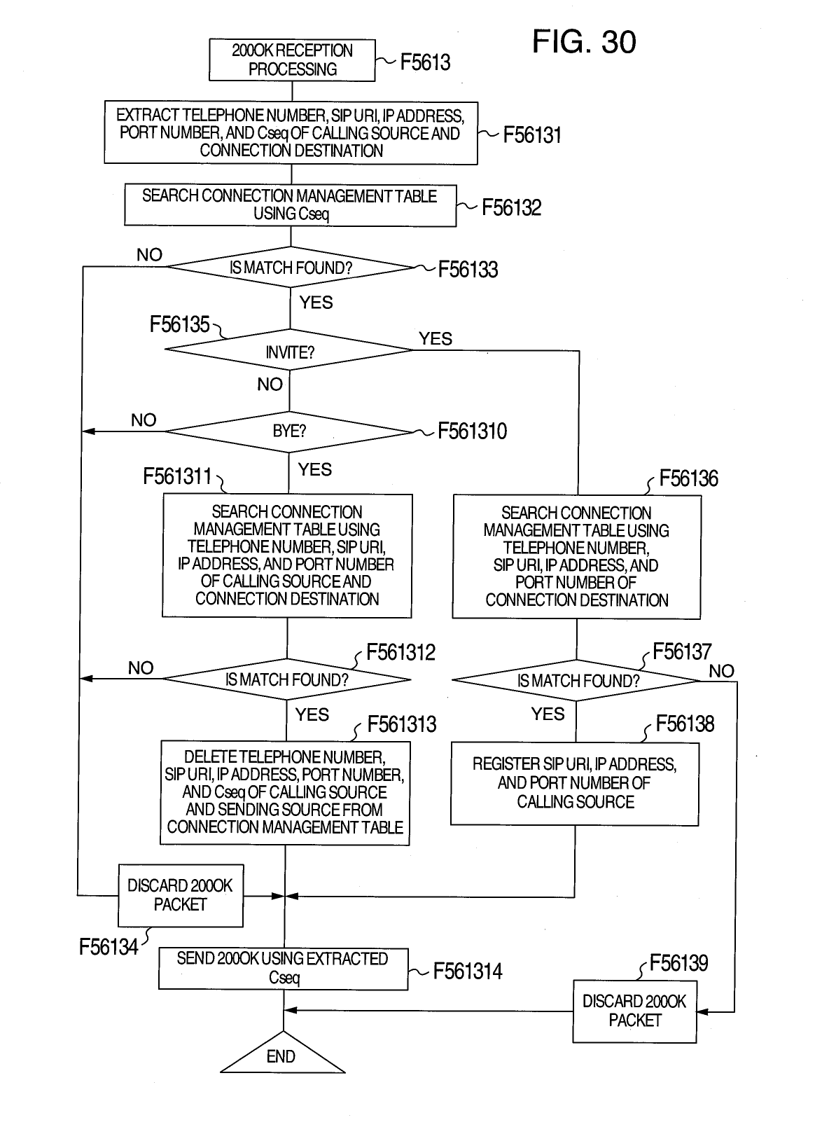

When the 200 OK packet SQ110 that is the response message to the INVITE packet SQ106, SQ107 that is the session connection request received from the connection destination is received, the SIP server 50 performs the processing according to the flow of the 200 OK reception processing F5613 shown in FIG. 30. That is, the SIP server 50 extracts the calling source and connection destination telephone numbers, SIP URI that is the identification information used in the SIP communication, IP address, port number, and command sequence Cseq that is the identification information on the SIP message F56131 and searches the connection management table 563, 5631, shown in FIG. 12B, using the command sequence Cseq that is the identification information on the extracted SIP message (F56132). The SIP server 50 checks if the search result indicates that there is a matching command sequence (F56133). If the search result indicates that there is not a match, the 200 OK packet that is the response message is discarded (F56134); if the search result indicates that there is a match, the SIP server 50 checks if the command sequence Cseq that is the identification information on the SIP message is the one for INVITE that is a session connection request (F56135). If the command sequence Cseq is not the one for INVITE, control is passed to F561310 in the flow to check if the command sequence is the one for BYE. The processing that is performed after F561310 in the flow will be described later.

If the packet is the 200 OK packet SQ110 that is the response to the INVITE that is the session connection request as shown in the connection management table 563, 5631 in FIG. 12B, the SIP server 50 searches the connection management table 563, shown in FIG. 12B, using the telephone number, SIP URI, IP address, and port number (F56136) of the connection destination to see if there is a match (matching entry is registered) (F56137). If there is not a match (matching entry is not registered), the 200 OK packet SQ110 is discarded F56139; if there is a match (a matching entry is registered), SIP URI and the port number of the calling source are registered as shown in the connection management table 563, 56312 shown in FIG. 12C (F56138). When the registration is completed, the SIP server 50 sends the 200 OK packet SQ111 to the connection destination using the command sequence Cseq (103 INVITE) that is the identification information on the extracted SIP message (F561314).

When the 200 OK packet SQ111 that is the response packet to the INVITE packet SQ106 that is the session connection request is received, the MG 30-1 performs the processing according to the flow of the 200 OK reception processing F3914 shown in FIG. 24. The description of the steps of the flow already described is omitted here, and the description begins at F391412 in the flow.

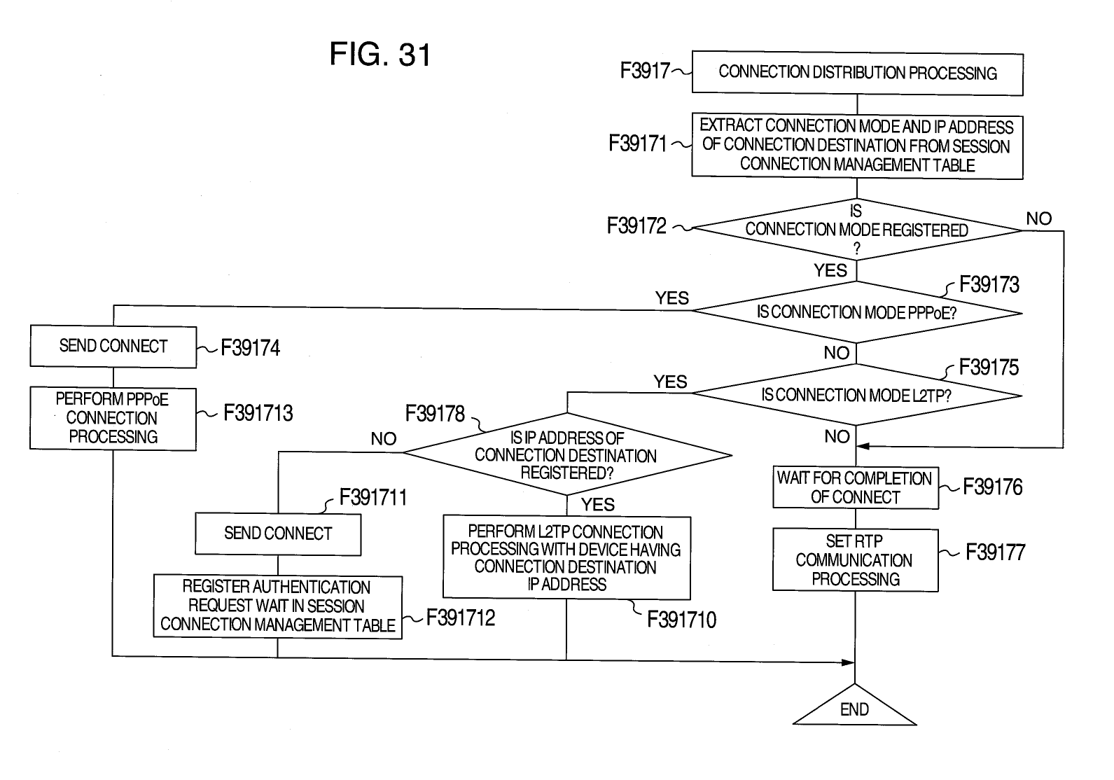

The MG 30-1 checks if the command sequence Cseq (F39144) that is the identification information on the extracted SIP message is the one for the INVITE packet SQ106, SQ107 (F391412). If the packet is the 200 OK packet SQ111 that is the response message to INVITE as shown in the session connection management table 393, 3931 shown in FIG. 8C, the MG 30-1 searches the session connection management table 393, shown in FIG. 8C, using the telephone number, SIP URI, IP address, port number, and connection mode of the extracted connection destination (F391413) and checks if the search result indicates a match (F391414). If there is not a match, the 200 OK packet SQ111 is discarded (F391417); if there is a match as shown in the session connection management table 393, 39312 shown in FIG. 8C, the MG 30-1 registers SIP URI, IP address, port number, and connection mode, as well as Cseq 39310, of the calling source in the session connection management table 393, 39313 shown in FIG. 8D (F391415) and sends ACK to the calling source (F391421). After ACK is sent, the MG 30-1 performs the connection distribution processing F3917 shown in FIG. 31.

After the 200 OK SQ111 that is the response packet to the SIP message INVITE SQ106, SQ107 that is the session connection request is received and the flow of the 200 OK reception processing F3914 shown in FIG. 24 is completed, the MG 30-1 performs the processing according to the flow of the connection distribution processing F3917 shown in FIG. 31. That is, the MG 30-1 extracts the connection mode from the session connection management table 393 shown in FIG. 8D (F39171) and checks if the connection mode is registered (F39172). If the connection mode is not registered as shown in the session connection management table 393, 39313 in FIG. 8D, the MG 30-1 waits for the telephone 2 14-2, which is the connection destination, to answer, that is, waits for CONNECT to be completed (F39176). The processing that is performed when the connection mode is registered in the session connection management table 393 shown in FIG. 8D will be described later.

CONNECT is completed when the MG 30-1 receives CONNECT message SQ113 and 200 OK message SQ114-SQ115 from the telephone 2 14-2, which is the receiving side, sends CONNECT to the telephone 1 10-1 SQ116, and sends the response message ACK SQ117 to the calling source of the 200 OK message.

After the processing described above, the CONNECT processing is completed. When the CONNECT processing is completed, the MG 30-1 performs the VoIP (Voice over Internet Protocol) communication (voice) processing F39159 via RTP (Real-time Transport Protocol).

After the processing described above, the processing operation of the MG 30-1 and the SIP server 50, required for the telephone 1 10-1 and the telephone 2 14-2 to start VoIP (Voice over Internet Protocol) communication via RTP (Real-time Transport Protocol), is completed. Now, the telephone 1 10-1 and the telephone 2 14-2 can perform a voice call SQ118-SQ120.

Next, referring to FIG. 16, the following describes the processing operation of the MG 30 and the SIP server 50 that is performed when the voice call SQ118-SQ120 between the telephone 1 10-1 and the telephone 2 14-2 is disconnected.

When DISC SQ121 that is a disconnection request message is received, the MG 30-1 extracts the telephone number of the calling source and checks if the telephone number is registered in the session connection management table 393, 3931 shown in FIG. 8D. If the telephone number is not registered, DISC SQ121 is discarded; if the telephone number is registered, the MG 30-1 registers the command sequence Cseq (104 BYE), which is the identification information on the SIP message, as shown in the session connection management table 393, 39314 in FIG. 8E, converts DISC (SQ121), which is the disconnection message from the line network from which the message was received, to the session disconnection request message BYE packet (SQ122) that is the SIP message, and sends the BYE packet to the connection destination (SQ122).

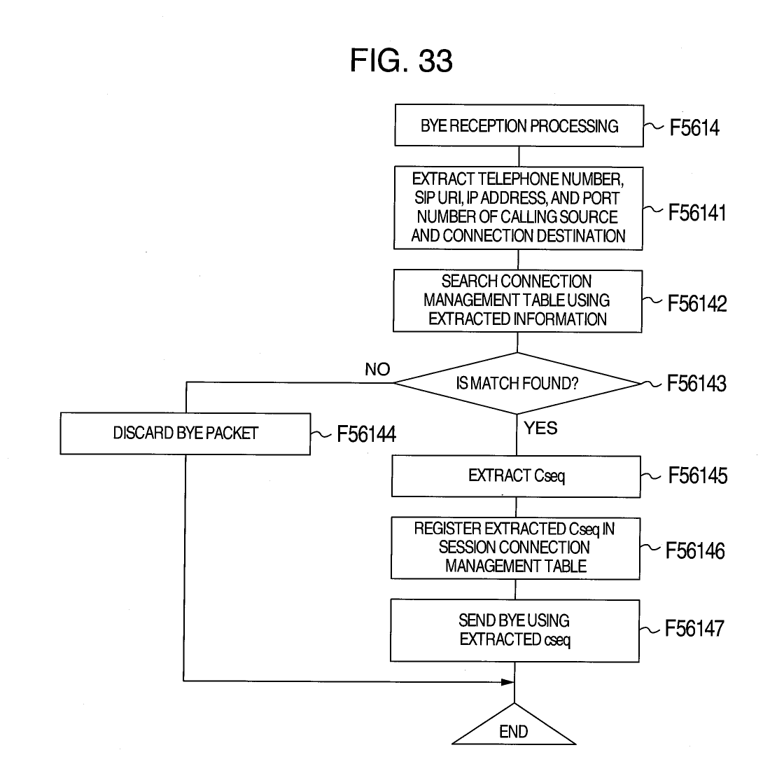

When the BYE packet SQ122 that is the session disconnection request message is received, the SIP server 50 performs the processing according to the flow of the BYE reception processing F5614 shown in FIG. 33. That is, the SIP server 50 extracts the telephone number, SIP URI that is the identification information used in the SIP communication, IP address, and port number of the calling source and the connection destination (F56141), and searches the connection management table, shown in FIG. 12C, using the extracted information (F56142). The SIP server 50 checks if there is matching information (F56143). If there is not matching information, the BYE packet SQ121 is discarded (F56144); if there is matching information, the SIP server 50 extracts the command sequence Cseq that is the identification information on the SIP message (F56145) and updates the command sequence Cseq (104 BYE), which is the identification information on the SIP message, as shown in the connection management table 563, 56313 shown in FIG. 12D F56146. After the registration is completed, the SIP server 50 sends the BYE packet SQ123, which is a session disconnection request, to the connection destination using the command sequence Cseq (104 BYE) that is the identification information on the registered SIP message (F56147).

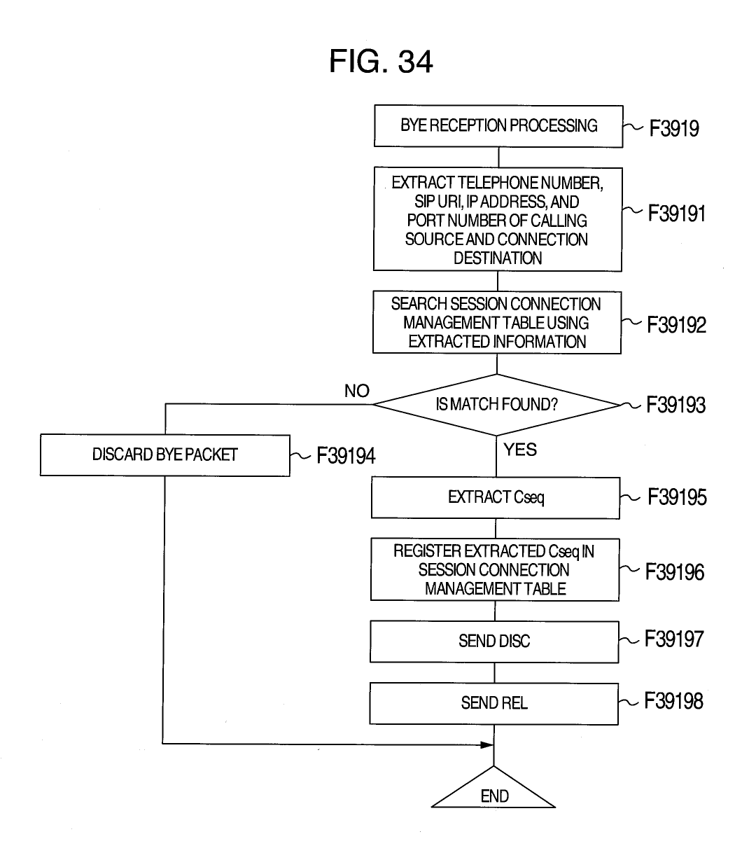

When the BYE packet SQ123 that is the session disconnection request is received, the MG 30-3 performs the processing according to the flow of the BYE reception processing F3919 shown in FIG. 34. That is, the MG 30-3 extracts the telephone number, SIP URI, IP address, and port number of the calling source and the connection destination F39191 and searches the session connection management table 393, shown in FIGS. 8A-8G, using the extracted information (F39192). The MG 30-3 checks the search result to see if there is matching information F39193. If there is not matching information, the BYE packet SQ123 that is the session disconnection request is discarded (F39194). If there is matching information, the MG 30-3 extracts the command sequence Cseq (104 BYE) that is the identification information on the SIP message F39195 and registers it in the connection management table 563 shown in FIGS. 8A-8G F39196. After the registration is completed, the MG 30-3 converts the disconnection request message BYE packet SQ123, received by the SIP message, to DISC SQ124 that is the disconnection request message on the line network side, sends them to the telephone 2 14-2 (F39197) and, in addition, sends REL SQ125 that is an release message (F39198).

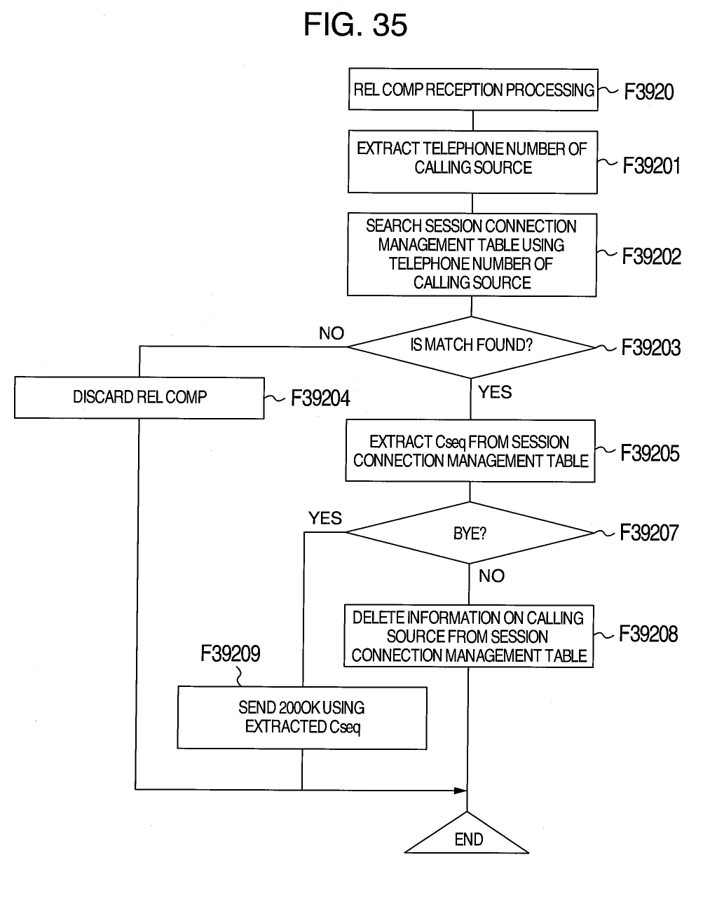

After the release processing is completed, REL COMP SQ126, which is the release completion message, is sent from the telephone 2 14-2. When the REL COMP SQ126 that is the release completion message is received, the MG 30-3 performs the processing according to the flow of the REL COMP reception processing F3920 shown in FIG. 35. That is, the MG 30-3 extracts the telephone number of the calling source (F39201) and searches the session connection management table 393, shown in FIGS. 8A-8G (F39202). If the search result indicates that there is not a match, REL COMP is discarded (F39204). If there is a match, the MG 30-3 extracts the command sequence Cseq, which is the identification information on the SIP message, from the session connection management table 393 shown in FIGS. 8A-8G (F39205). If the command sequence is the one for BYE, the MG 30-3 sends the 200 OK packet SQ127 to the SIP server 50 using the command sequence Cseq that is the identification information on the extracted SIP message. The processing that is performed when the command sequence is not the one for BYE will be described later.

When the 200 OK packet SQ127 that is the response message to the BYE packet SQ122 that is the session disconnection request is received, the SIP server 50 performs the processing according to the flow of the 200 OK reception processing F5613 shown in FIG. 30. The description of the already described flow is omitted here, and the description begins at F561310 in the flow.

The SIP server 50 checks if the command sequence Cseq, which is the identification information on the SIP message extracted from the received 200 OK packet SQ127, is the one for BYE (F561310). If the command sequence is not the one for BYE, the 200 OK packet is discarded (F56134). If the command sequence is the one for BYE as shown in the connection management table 563, 56313 shown in FIG. 12D, the SIP server 50 searches the connection management table D shown in FIG. 12D using the telephone number, SIP URI that is the identification information used in the SIP communication, IP address, and port number of the calling source and the connection destination (F561311) to check if there is matching registered information (F561312). If there is not a match, the 200 OK packet SQ127 is discarded (F56134). If there is a match, the registered information on the calling source and the connection destination is deleted as shown in FIG. 12E (F561313). After the deletion processing is completed, the SIP server 50 sends the 200 OK packet SQ128 to the MG 30-1 using the command sequence Cseq (104 BYE) that is the identification information on the extracted SIP message (F561314).

When the 200 OK packet SQ128 that is the response message to the BYE packet SQ122 that is the disconnection request packet is received, the MG 30-1 performs the processing according to the flow of the 200 OK reception processing F3914 shown in FIG. 24.

The description of the processing of the flow already described is omitted here, and the description begins at F391416 in the flow. The MG 30-1 checks if the command sequence Cseq, which is the identification information on the SIP message extracted from the received 200 OK packet SQ128, is BYE (F391416). If the command sequence is not the one for BYE, the 200 OK packet is discarded (F391417). If the 200 OK packet is the one for BYE, which is the disconnection request message, as in the session connection management table 393, 39314 shown in FIG. 8E, the MG 30-1 searches the session connection management table 393, shown in FIG. 8E, using the telephone number, SIP URI, IP address, port number, and connection mode of the calling source and the connection destination (F391418). The MG 30-1 checks the search result for a match (F391419). If there is not a match, the 200 OK packet is discarded (F391417). If there is a match, the MG 30-1 deletes the information on the calling source and the command sequence Cseq, which is the identification information on the SIP message, as shown in the session connection management table 393,39315 in FIG. 8F (F391420). After the deletion processing is completed, the MG 30-1 sends ACK SQ129, which is the response message, to MG 30-3 (F391421) and, in addition, sends REL SQ130, which is the call release message, to the calling source.

When the call release completion message REL COMP SQ131 returned in response to REL SQ130, which is the call release message, is received, the MG 30-1 performs the processing according to the flow of the REL COMP reception processing F3920 shown in FIG. 35. The description of the processing of the flow already described is omitted here, and the description begins at F39207 in the flow. The MG 30-1 checks if the command sequence Cseq, which is the identification information on the SIP message extracted from the session management table, is the one for BYE (F391207). If the command sequence is not the one for BYE, the MG 30-1 deletes the information on the calling source as in the session connection management table 393 shown in FIG. 8G (F39208).

After the above processing, the voice call is disconnected.

This completes the description of the processing operation of the MG 30 and the SIP server 50 when the telephone 1 10-1 and the telephone 2 14-2 starts and disconnects the voice call.

### SECOND EMBODIMENT

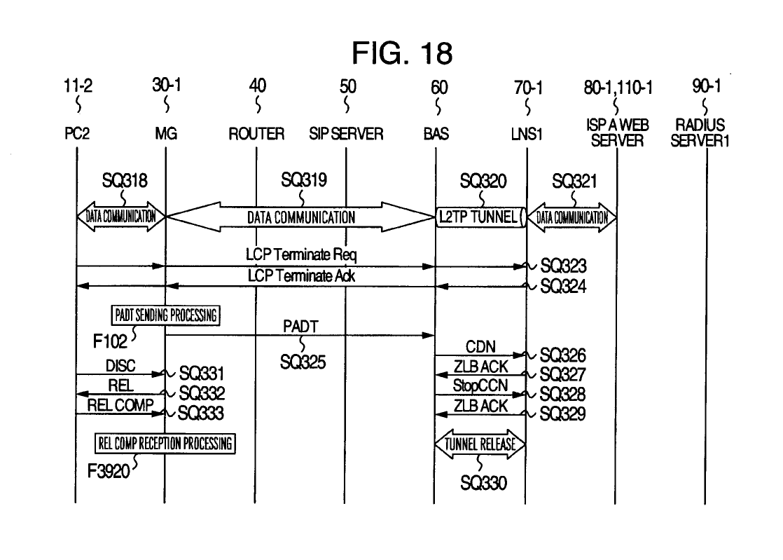

Next, a second embodiment will be described. FIG. 17 is a diagram showing the communication sequence and the protocol stack when the PC2 11-2 performs the data communication, indicated by the circled numeral 2 in FIG. 2, with the web server 110-1 in the ISP A 80-1. FIG. 18 is a diagram showing the communication sequence when the PC2 11-2 disconnects the data communication, indicated by the circled numeral 2, with the web server 110-1 in the ISP A 80-1.

Referring to the communication sequences shown in FIG. 17 to FIG. 18 and the flowcharts shown in FIG. 21 to FIG. 35, the following describes the processing operation of the MGs 30-1 and 30-2 and the SIP server 50 in the second embodiment when the PC2 11-2 starts the data communication, indicated by the circled numeral 2, with the web server 110-1 in the ISP A 80-1.

First, the following describes the processing before the data communication, indicated by the circled numeral 2, is started. The processing of SQ104-SQ106 shown in FIG. 17, the SETUP reception processing F3912 shown in FIG. 25, and the calling processing F3913 shown in FIG. 26 is the same as that in the first embodiment and so the description is omitted here.

When the INVITE packet SQ106 that is the session connection request is received, the SIP server 50 performs the processing according to the flow of the INVITE reception processing F5612 shown in FIG. 27. The description of the processing that is the same as that in the first embodiment is omitted here and the description begins at F56126 in the flow.

The SIP server 50 searches the subscriber information management table 562, shown in FIG. 11A, using the telephone number of the connection destination to check if the connection mode is registered F56126. If the connection mode is registered as shown in the subscriber information management table 562, 5626 shown in FIG. 11A, the SIP server 50 extracts the connection mode 5624 and the IP address 5623 of the connection destination F56129. As shown in the connection mode 5624 in FIG. 11A, it is found that, in the second embodiment, the connection mode is PPPoE and the communication is the data communication.

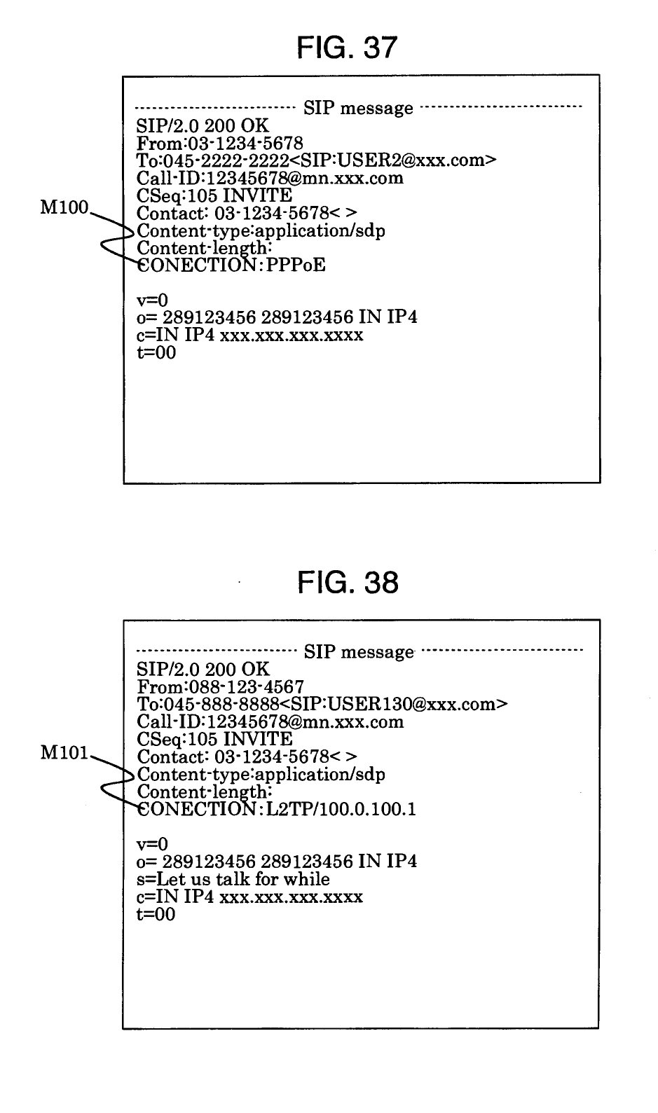

After the connection mode and the IP address are extracted F56129, the SIP server 50 sets Cseq 105 INVITE that is the identification information on the SIP message and, in addition, sends the 200 OK packet SQ300, in which is set connection mode and the IP address are added in the SIP message, to the calling source (F561210). FIG. 37 is a diagram showing an example of the 200 OK packet SQ300 generated in this case. Note that the extracted IP address of the connection destination described above may not sometimes be registered. Although the MG 30 does not know the connection destination when the IP address is not registered, there is no problem if only the connection mode is added to the 200 OK packet. The processing that is performed when only the connection mode is registered will be described later.

In the description below, CONNECTION:PPPoE (M100) is added to the header field, as shown in the example of the 200 OK packet in FIG. 37, to inform MG 30-1 of the connection mode. Because the SIP message is a text-based message, the connection mode may be specified in any other method.

If the connection mode is registered as RTP (Real-time Transport Protocol) or VoIP (Voice over Internet Protocol), the processing described in the first embodiment is performed instead of the processing described above, that is, the session connection request message INVITE is sent to the connection destination.

As described above, the SIP server 50 determines whether to return 200 OK to the calling source or send INVITE to the connection destination based on the information on the connection mode in the second embodiment. That is, based on the information on the connection destination, the SIP server 50 determines which communication is to be performed, voice communication or data communication. When data communication is to be performed, the SIP server 50 sends the SIP message 200 OK to inform the MG 30 that the data communication is to be performed. The above operation allows the MG 30 to identify the communication type, voice or data, and to perform the operation according to the connection mode. In this embodiment, the MG 30 operates as a PPPoE client.

When the 200 OK packet SQ300 is received, the MG 30-1 performs the processing according to the flow of the 200 OK reception processing F3914 shown in FIG. 24. The description of the flow already described in the first embodiment is omitted here, and the description begins at F391412 in the flow. The MG 30-1 checks if the command sequence Cseq, which is the identification information on the extracted SIP message, is the one for INVITE (F391412). If the command sequence is the one for INVITE as shown in the session connection management table 393, 39316 shown in FIG. 8C, the MG 30-1 searches the session connection management table 393, 39316, shown in FIG. 8C, using the telephone number, SIP URI, IP address, port number, and connection mode of the connection destination (F391413) to see if there is a match. If there is not a match, the 200 OK packet is discarded (F391317). If there is a match, the MG 30-1 registers the SIP URI, IP address, port number, and connection mode of the calling source as shown in the session connection management table 393, 39317 shown in FIG. 8D and, in addition, deletes the command sequence Cseq that is the identification information on the SIP message (F391415). This embodiment differs from the first embodiment in that the connection mode is registered.

After the 200 OK processing F3915 is completed as described above, the MG 30-1 performs the processing according to the flow of the connection distribution processing F3917 shown in FIG. 31. That is, the MG 30-1 extracts the connection mode and the IP address of the connection destination from the session connection management table 393, 39317 shown in FIG. 8D F39171 to check if the connection mode is registered (F39172). The MG 30-1 checks if the connection mode is PPPoE (F39173). If the checking result indicates that the connection mode is PPPoE as shown in the session connection management table 393, 39317 shown in FIG. 8D, the MG 30-1 sends CONNECT SQ322 to the PC2 11-2 (F39174). After CONNECT SQ322 is sent, the MG 30-1 operates as a PPPoE client and performs the PPPoE connection processing with the BAS 60 (F391713). The BAS 60 and the LNS1 70-1 are connected via L2TP. The processing that is performed when the connection mode is not PPPoE will be described in a third embodiment.

The PPPoE session between the MG 30 and the BAS 60 eliminates the need for the information on the IP address of the connection destination and so on. The connection to the connection destination is made by the BAS 60.

Because the PPPoE connection processing and the L2TP connection processing SQ131-SQ154 are known technology, the detailed description is omitted here.

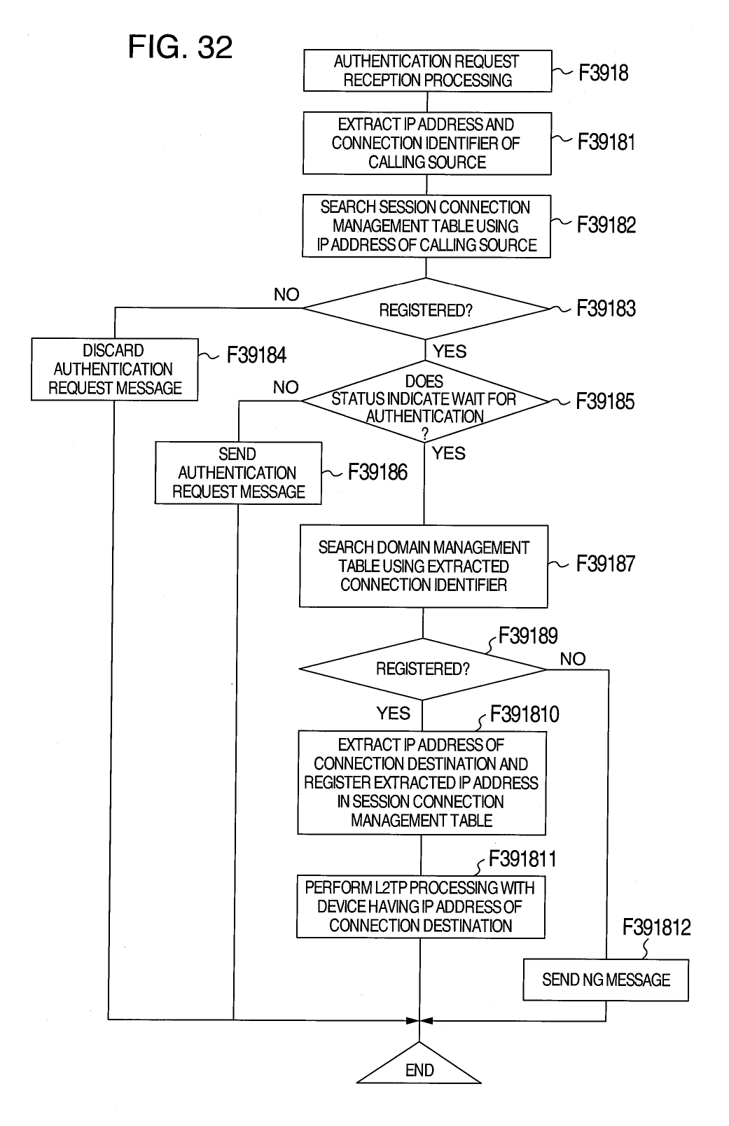

When the authentication request message SQ310 is received after the PPPoE session connection sequence (PPPoE discovery stage) SQ302-SQ305 and the PPP session connection sequence SQ306-SQ309, the MG 30-1 performs the processing according to the flow of the authentication request reception processing F3918 shown in FIG. 32. That is, the MG 30-1 extracts the IP address and the connection identifier (connection identifier: user ID allocated for each ISP that is used) of the calling source (F39181) and searches the session connection management table 393, 39317, shown in FIG. 8D, using the IP address of the calling source (F39182). The MG 30-1 checks the search result to see if the IP address is registered (F39183). If the IP address is not registered, the authentication request message SQ310 is deleted. If IP address is registered, the MG 30-1 checks if STATUS 39311 indicates a wait for an authentication request (F39185). Because the IP address is not registered as shown in the session connection management table 393, 39317 in FIG. 8D in this embodiment, the MG 30-1 sends the authentication request to the BAS 60 (F39186). After that, the L2TP connection processing SQ312 is performed between the BAS 60 and the LNS1 70-1 to form the L2TP tunnel SQ313. After the tunnel is formed, the RADIUS server 1 90-1 performs authentication and notifies the authentication result SQ314-SQ316. After the authentication is established, IPCP processing SQ317 is performed and it becomes possible to start data communication.

In the PPPoE connection processing F391713, the information on the added SESSION ID is managed in the data management table 394 shown in FIG. 9A. In this case, “#3” of connection mode “PPPoE #3” in the session connection management table 393, 39317, shown in FIG. 8C, indicates that the information is registered as the third entry of the data management table. In the second embodiment, SESSION ID is “55” as shown in the data management table 394, 3946 in FIG. 9A. The registration and management of SESSION ID is not limited to the method described above.

The above processing allows the PC2 11-2 to perform the data communication SQ157-SQ160, indicated by the circled numeral 2, with the web server 110-1 in the ISP A 80-1.

Referring to FIG. 18, the following describes how the PC2 11-2 disconnects the data communication, indicated by the circled numeral 2, with the web server 110-1 in the ISP A 80-1.

First, when the transfer of the LCP Terminate Req packet SQ323 that is the PPP session release request and the LCP Terminate Ack packet SQ324 that is the response to the PPP session release request is completed between the PC2 11-2 and LNS1 70-1, the PPP session is released. When the PPP session is released, the various information on the connection destination is deleted as shown in the session connection management table 393, 39318 shown in FIG. 8E.

After the PPP session is released, the MG 30-1 performs the PADT sending processing F102 to send the PADT packet SQ325 to the BAS 60 to notify that the PPPoE session is released. In this case, as shown in the data management table 394 shown in FIG. 9B, the MG 30-1 deletes the PPPoE session ID and, after that, sends the PADT packet SQ325.

When the PADT packet SQ325 is received, the BAS 60 performs the L2TP disconnection processing SQ326-SQ330. Because the L2TP disconnection processing SQ326-SQ330 is a known technology, the description is omitted here.

Next, when DISC SQ331 that is the call disconnection message is received, the MG 30-1 extracts the telephone number of the calling source and checks if the telephone number is registered in the session connection management table 393 shown in FIG. 8E. If the telephone number is not registered, DISC SQ331 is discarded. If the telephone number is registered, the MG 30-1 checks if the information on the connection destination is registered in the session connection management table shown in FIG. 8E. If the information on the connection destination is registered, DISC SQ331 is deleted. If the information on the connection destination is not registered, the MG 30-1 sends REL SQ332 to the calling source to notify the calling source that the connection will be released. When REL COMP SQ333 indicating the completion of release is received in response to the release notification, the MG 30-1 performs the processing according to the flow of the REL COMP reception processing F3920 shown in FIG. 35. That is, the MG 30-1 extracts the telephone number of the calling source F39201 and searches the session connection management table 393, shown in FIG. 8E, using the telephone number of the calling source (F39202). If the search result indicates that there is not a matching telephone number, REL COMP is discarded (F39204). If there is a matching telephone number, the MG 30-1 extracts the command sequence Cseq that is the identification information on the SIP message in the session connection management table (F39205), and checks if the command sequence is the one for BYE (F39207). Because the command sequence is not the one for BYE the example of this embodiment, the MG 30-1 deletes the information on the calling source as in the session connection management table shown in FIG. 8F (F39208).

After the above processing, the disconnection of the data communication, indicated by the circled numeral 2, is completed.

### THIRD EMBODIMENT

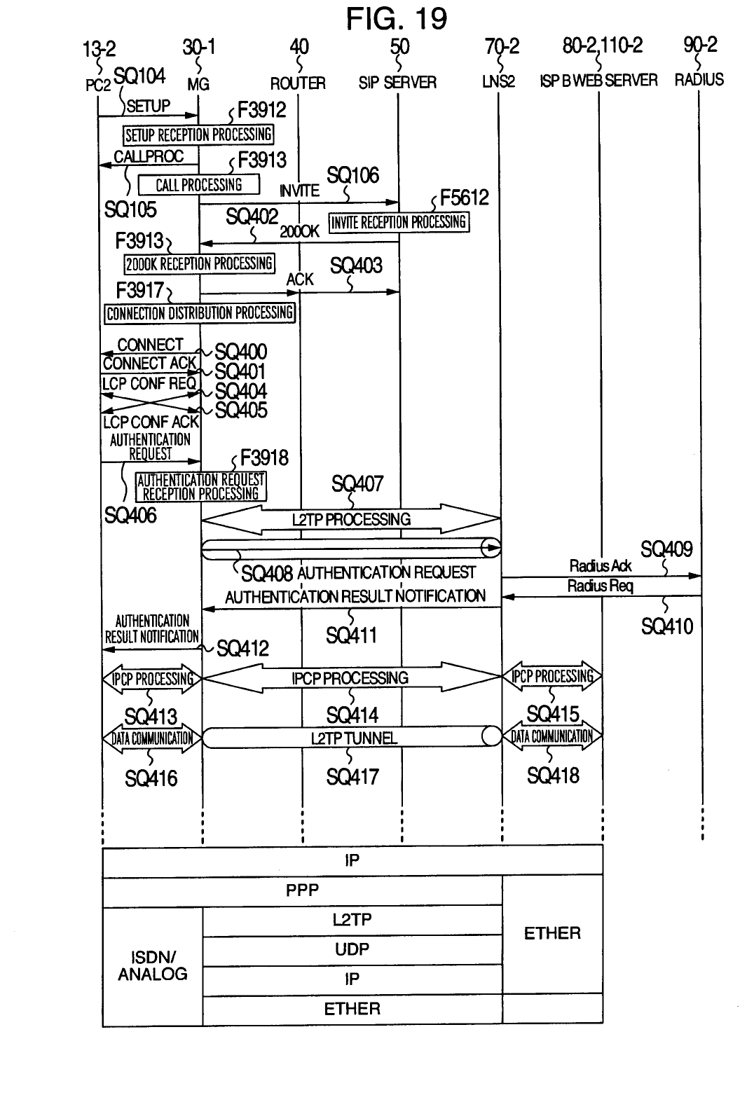

Next, a third embodiment will be described. FIG. 19 is a diagram showing the communication sequence and the protocol stack when the PC2 13-2 performs the data communication, indicated by the circled numeral 3 in FIG. 2, with the web server 110-2 in the ISP B 80-2.

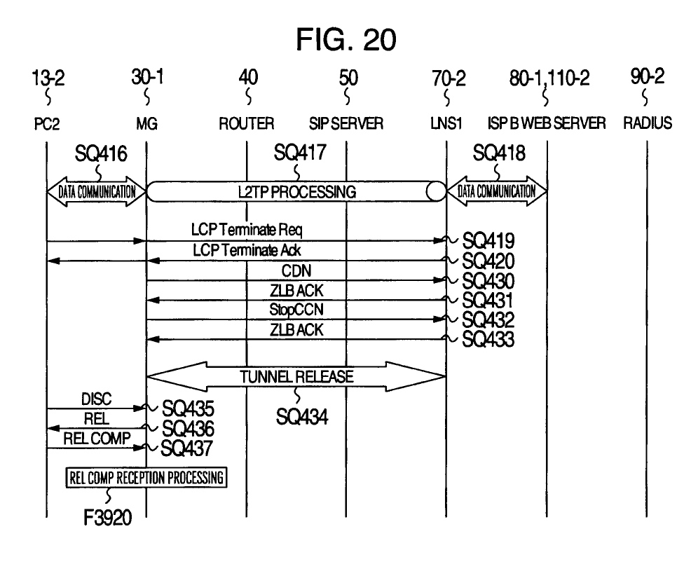

FIG. 20 is a diagram showing the communication sequence that is performed when the PC2 13-2 disconnects the data communication, indicated by the circled numeral 3, with the web server 110-2 in the ISP B 80-2.

Referring to the communication sequences in FIG. 19-FIG. 20 and the flowcharts in FIG. 21-FIG. 35, the following describes the processing operation of the MG 30 and the SIP server 50 in the third embodiment of the present invention.

First, the following describes the processing that is performed before the PC2 13-2 starts the data communication, indicated by the circled numeral 3 shown in FIG. 2, with the web server 110-2 in the ISP B 80-2. SQ104-SQ106 shown in FIG. 19, the SETUP reception processing F3912 shown in FIG. 25, and the calling processing F3913 shown in FIG. 26 are the same as the processing in the first embodiment and so the description is omitted here.

When the INVITE packet SQ106 that is the session connection request is received, the SIP server 50 performs the processing according to the flow of the INVITE reception processing F5612 shown in FIG. 27. The description of the processing that is the same as that in the first embodiment is omitted here and the description begins at F56126 in the flow.

The SIP server 50 searches the subscriber information management table 562, shown in FIG. 11A, using the telephone number of the connection destination and checks if the connection mode is registered (F56126). If the connection mode is registered as shown in the subscriber information management table 562, 5627, 5628 shown in FIG. 11A, the SIP server 50 extracts the connection mode 5624 and the IP address 5623 of the connection destination (F56129). As shown in the connection mode 5624 in FIG. 11A, it is found in the third embodiment that the connection mode is the data communication via L2TP.

In the third embodiment, there are two patterns as shown in the subscriber information management table 562, 5627, 5628 shown in FIG. 11A: one is the pattern in which both connection mode and the IP address of the connection destination are registered 5627 and the other is the pattern in which only the connection mode is registered 5628. In the second embodiment, the PADI SQ302 can be broadcast to the BAS even if the IP address of the connection destination is not known because the PPPoE connection is used, that is, data is transferred over a layer 2 network, and the PPPoE session can be established with the BAS 60 from which a response is received. In contrast, in the third embodiment, the IP address of the connection destination is required. In the description below, the pattern in which there is no IP address will be described as necessary.

After the connection mode and the IP address are extracted F56129, the SIP server 50 sets Cseq 106 INVITE that is the identification information on the SIP message and sends the 200 OK packet SQ402, in which the connection mode and the IP address are specified in the SIP message, to the calling source F561210. FIG. 38 is a diagram showing an example of the 200 OK packet SQ402 used in this case.

In this example, CONNECTION:L2TP/100.0.100.1 M101 is added to the header field as shown in the example of the 200 OK packet in FIG. 38 to notify the MG 30-1 about the connection mode. The IP address in the last half is added when not only the connection mode but also the IP address is registered. Note that, because the SIP message is a text-based message, the connection mode may be specified in any other method.

When RTP (Real-time Transport Protocol) or VoIP (Voice over Internet Protocol) is registered as the connection mode, the SIP server 50 performs, not the processing described above, but the processing described in the first embodiment, that is, the processing in which the session connection request message INVITE is sent to the connection destination.

As described above, the SIP server 50 determines whether to return 200 OK to the calling source or send INVITE to the connection destination based on the information on the connection mode in the third embodiment. That is, based on the information on the connection destination, the SIP server 50 determines which communication is to be performed, voice communication or data communication. When data communication is to be performed, the SIP server 50 sends the SIP message 200 OK to inform the MG 30 that the data communication is to be performed. The above operation allows the MG 30 to identify the communication type, voice or data, and to perform the operation according to the connection mode. In this embodiment, the MG 30 operates as a LAC.

When the 200 OK packet SQ402 is received, the MG 30-1 performs the processing according to the flow of the 200 OK reception processing F3914 shown in FIG. 24. The description of the flow already described in the first embodiment is omitted here, and the description begins at F391412 in the flow. The MG 30-1 checks if the command sequence Cseq, which is the identification information on the extracted SIP message, is the one for INVITE (F391412). If the command sequence is the one for INVITE, the MG 30-1 searches the session connection management table 393, 39319, shown in FIG. 8C, using the telephone number, SIP URI, IP address, port number, and connection mode of the connection destination to see if there is a match (F391413). If there is not a match, the 200 OK packet is discarded (F391317). If there is a match, the MG 30-1 registers the SIP URI, IP address, port number, and connection mode of the calling source as shown in the session connection management table 393, 39320 shown in FIG. 8D and, in addition, deletes the command sequence Cseq that is the identification information on the SIP message (F391415). This embodiment differs from the first embodiment in that the connection mode is registered.

After the 200 OK processing F3915 is completed as described above, the MG 30-1 performs the processing according to the flow of the connection distribution processing F3917 shown in FIG. 31. That is, the MG 30-1 extracts the connection mode and the IP address of the connection destination from the session connection management table 393, 39320 shown in FIG. 8D (F39171) to check if the connection mode is registered (F39172). The MG 30-1 checks if the connection mode is PPPoE (F39173) and, if not, checks if the connection mode is L2TP (F39175). If the connection mode is L2TP, the MG 30-1 checks if the IP address of the connection destination is registered (F39178). If the IP address of the connection destination is registered as in the session connection management table 393, 39320 shown in FIG. 8D, the MG 30-1 sends CONNECT SQ400, which indicates a connection request, to the PC2 13-2 and starts the L2TP connection processing with the device that has the IP address of the connection destination (F39179). If the IP address of the connection destination is not registered as shown in the session connection management table 393, 39321 shown in FIG. 8D, the MG 30-1 sends CONNECT SQ400, which indicates a connection request, to the PC2 13-2 (F391711) and registers an authentication request wait as shown in the session connection management table 393, 39322 shown in FIG. 8E (F391712).

If the IP address of the connection destination is registered in the case described above, the MG 30-1 can start the L2TP connection processing with the connection destination device. If the IP address of the connection destination is not registered, the MG 30-1 cannot start the connection. Therefore, the MG 30-1 solves this problem in the processing described below.

After that, when the authentication request SQ406 is received, the MG 30-1 performs the processing according to the flow of the authentication request reception processing F3918 shown in FIG. 32. That is, the MG 30-1 extracts the IP address and the connection identifier (connection identifier: user ID allocated for each ISP that is used) of the calling source F39181 and searches the session connection management table 393, 39322, shown in FIG. 8E, using the IP address of the calling source (F39182). The MG 30-1 checks the search result to see if the IP address is registered (F39183). If the IP address is not registered, the authentication request message SQ406 is deleted. If IP address is registered, the MG 30-1 checks if STATUS 39311 indicates a wait for an authentication request (F39185). In this embodiment, because the IP address is registered as shown in the session connection management table 393, 39317 shown in FIG. 8E, the MG 30-1 searches the domain management table 395, 3953, shown in FIG. 10, using the extracted connection identifier F39187 to check if the IP address is registered (F39171). If the IP address is registered, the MG 30-1 extracts the IP address of the connection destination and registers the IP address as shown in the session connection management table 393, 39323 shown in FIG. 8F (F391810). After the registration is completed, the MG 30-1 performs the L2TP connection processing with the device at the connection destination (F391811).

If the IP address is not registered in the domain management table 395 shown in FIG. 10, the MG 30-1 sends the NG response such as a message indicating that the IP address is not registered (F391812).

The method described above allows the IP address of the connection destination to be identified. Although managed in the domain management table in the MG 30 in the present invention, the IP address may also be obtained by querying RADIUS server. After the L2TP connection processing SQ407, authentication processing SQ406, SQ408-SQ412, and IPCP processing SQ416-SQ418, it becomes possible to perform the data communication. Because those types of processing are known technologies, the detailed description is omitted here.

In the L2TP connection processing F39154, the information on the added SESSION ID and TUNNEL ID is managed in the data management table 394 shown in FIG. 9A. In this case, “#1” of the connection mode “L2TP#1” in the session connection management table 393, shown in FIG. 8C, indicates that the information is registered as the first entry of the data management table. In the third embodiment, SESSION ID is “1” and TUNNEL ID is “1” for the MG 30-1 and SESSION ID is “10” and TUNNEL ID is “10” for the connection destination, as shown in the data management table 394, 3947 in FIG. 9A. The registration and management of SESSION ID and TUNNEL ID is not limited to the method used by the present invention.

In this embodiment, too, the information on the connection mode allows the SIP server to identify the communication type, voice or data, and the SIP message allows the MG 30 to identify the communication type, voice or data, in the same way as in the second embodiment. In addition, the information on the connection method allows the MG 30 to operate as a LAC in the third embodiment.

Next, the following describes the processing in which the PC2 13-2 disconnects the data communication, indicated by the circled numeral 3 shown in FIG. 2, with the web server 110-2 in the ISP B 80-2.

First, the LCP Terminate Req packet SQ419 is sent to release the PPP session, the LCP Terminate Ack packet SQ420 is sent as the response to the PPP session release, and the PPP session is released. After that, the L2TP disconnection processing SQ430-SQ434 is performed. Because the processing of L2TP is a known technology and so the detailed description is omitted here.

As described above, the L2TP tunnel is released SQ434 by the PPP session release processing and the L2TP disconnection processing, and the data communication, indicated by the circled numeral 3, is terminated. At this time, the information on the connection destination is deleted as shown in the session connection management table 393, 39324 shown in FIG. 8E. In addition, as shown in FIG. 9B, TUNNEL ID “1” and SESSION ID “1” on the MG 30-1 side and TUNNEL ID “10” and SESSION ID “10” on the LNS2 70-2 side are deleted.

Next, when the call disconnection message DISC SQ435 is received, the MG 30-1 extracts the telephone number of the calling source and checks if the telephone number is registered in the session connection management table 393 shown in FIG. 8E. If the telephone number is not registered, DISC SQ435 is discarded. If the telephone number is registered, the MG 30-1 checks if the information on the connection destination is registered in the session connection management table shown in FIG. 8E. If the information on the connection destination is registered, DISC SQ435 is deleted. If the information on the connection destination is not registered, the MG 30-1 sends REL SQ436 to the calling source to indicate the release. When REL COMP SQ437 indicating the completion of release is received in response to the release notification, the MG 30-1 performs the processing according to the flow of the REL COMP reception processing F3920 shown in FIG. 35. That is, the MG 30-1 extracts the telephone number of the calling source (F39201) and searches the session connection management table 393, shown in FIG. 8E, using the telephone number of the calling source (F39202). If the search result indicates that there is not a match, the REL COMP is discarded (F39204). If there is a match, the MG 30-1 extracts the command sequence Cseq that is the identification information on the SIP message in the session connection management table (F39205) and checks if the command sequence is the one for BYE (F39207). Because the command sequence is not the one for BYE in the example of this embodiment, the MG 30-1 deletes the information on the calling source as in the session connection management table shown in FIG. 8F (F39208).

The processing from the start of data communication to the call disconnection is completed, and the disconnection of the data communication, indicated by the circled numeral 3, is completed.

It should be further understood by those skilled in the art that although the foregoing description has been made on embodiments of the invention, the invention is not limited thereto and various changes and modifications may be made without departing from the spirit of the invention and the scope of the appended claims.

1. A communication system comprising:
a plurality of terminals;
a management device connected to said terminals;
a network connected to said management device;
a server connected to said network; and
a first table in which information regarding a connection status on said network is stored,
said management device comprising:
a second table in which information regarding said terminals is stored;
a third table in which information regarding sessions performed via said network is stored;
a fourth table in which information regarding service providers connected via said network is stored; and
an interface that controls a connection between said terminals and said network based on information read from said second table, said third table, and said fourth table wherein
when a session connection request is received from said management device, said server sends a response message to said management device based on information read from said first table.

2. The communication system according to claim 1, wherein
said management device determines a type of service, to which a user of said terminals subscribes, based on information read from said second table and said interface controls a connection with said network according to the type of service.

3. The communication system according to claim 1, wherein
the information on a connection status includes information used to determine which communication, data communication or voice communication, is carried out on said network.

4. The communication system according to claim 1, wherein
the information on a connection status is communication condition information on said network and said server determines which communication, data communication or voice communication, is carried out on said network based on information read from said first table.

5. The communication system according to claim 1, wherein
said server comprises a processing unit that performs SIP-protocol based session control based on information read from said first table.

6. The communication system according to claim 1, wherein
said second table stores type information on a line to which said terminals connect, setting information on a time division switch of the management device to which said terminals connect, and service information on a user of said terminals.

7. The communication system according to claim 1, wherein
said second table stores type information on lines, ISDN or analog, to which said terminals connect and said network is an Internet protocol network.

8. The communication system according to claim 1, wherein
said first table is stored in said server.

9. The communication system according to claim 1, wherein
said second table is stored in said management device.

10. The communication system according to claim 1, further comprising
a control terminal connected to said server for controlling information stored in said first table.

11. The communication system according to claim 1, wherein
said management device further comprises a fifth table in which PPPoE session information is stored.

12. The communication system according to claim 1, further comprising
a sixth table in which connection management information, related to the information on a connection status, is stored.

13. The communication system according to claim 1, wherein
said third table stores telephone numbers of connection destination terminals connected via said network, telephone numbers of calling source terminals, and addresses on said network and said management device sends messages to said server based on messages received from said terminals and information read from said third table.

14. The communication system according to claim 12, wherein, when a session disconnection request message is received, said server searches said sixth table for connection management information based on information read from said first table.

15. The communication system according to claim 1, wherein
said server determines which communication, data communication or voice communication, is carried out on said network based on information read from said first table and, when the communication is the data communication, sends a response message, to which connection information is added, to said management device.
